(19) United States
(12) Patent Application Publication
(10) Pub. No.: US 2026/0209479 A1
(43) Pub. Date: Jul. 23, 2026

(54) SEQUINS AND METHOD OF MANUFACTURING SEQUINS

(71) Applicant: Radiant Matter Ltd, London (GB)

(72) Inventors: Elissa BRUNATO, London (GB); Cyan WILLIAMS, London (GB)

(21) Appl. No.: 19/134,928

(22) PCT Filed: Dec. 1, 2023
(86) PCT No.: PCT/GB2023/053113

§ 371 Date: Jun. 2, 2025

(30) Foreign Application Priority Data
Dec. 2, 2022 (GB) 2218182.0

(51) Int. Cl. C08L 1/02; B44F 1/14

(52) U.S. Cl. CPC C08L 1/02; B44F 1/14; C08L 2205/06; C08L 2312/00

(57) ABSTRACT

A membrane formed of a self-assembled microstructure of anisotropic nanocrystals is described. The membrane has an upper surface, a lower surface, a centroid and a perimeter. In a first type of membrane, around a majority of the perimeter the membrane curves back on itself. A second type of membrane is shaped such that moving from the upper surface to the lower surface around any point on the perimeter, a minimum radius of curvature (rₘᵢₙ) is at least 0.1 times the thickness of the membrane at the centroid.

### FIELD OF THE INVENTION

The present disclosure relates to membrane formed of a self-assembled microstructure of anisotropic nanocrystals, articles include such membranes, and methods for forming the membranes and articles. Amongst other applications, the membranes may be used to provide sequins or bio iridescent sequins and method of manufacturing said sequins, for example biodegradable sequins made from a cellulose-based material, for example cellulose nanocrystals (CNC).

### BACKGROUND

Embroidery is the art of embellishing a textile with additional material to elevate the final garment's qualities. Materials are most commonly applied in the form of beads, sequins, thread, gems and crystals. Through design and various application techniques, these materials can transform a textile, enhancing aesthetic, tactile or functional qualities and/or adding cultural significance and purpose.

Sequins (or “pailettes” or “spangles”) are small ornamental shiny disks of various shapes and sizes, that are often sewn onto garments in high quantity to create a shimmering effect. Originally these disks were made of metal and acted as strong cultural symbols.

However, the evolution of technologies, industrial mining and machinery caused for the sequin to now commonly be made from low-cost plastic.

The essence of a sequin is to be shiny. What was once an alluring quality only afforded by society's highly ranked, has now become a mass commodity due to the low cost and formable properties of modern-day plastic. Shine can be imitated through the use of

petroleum and varying shimmering-coloured coatings that are derived from similar chemical mixtures.

The most widely used sequins are predominantly made of PVC (Polyvinyl Chloride), or PET (Polyethylene Terephthalate). These plastics are chemical polymers derived from petroleum. They come with various surface finishes such as matte, silk, two-toned, pearl, mirror, metallic and iridescent.

In 2017, the Ellen MacArthur Foundation® released a research report, A New Textiles Economy: Redesigning Fashion's Future, which brought forward concerning issues regarding the use of petrochemicals in the textiles industry and the leakage of micro-plastics into the environment. In the last decade reports have remarked that “The PVC lifecycle—its production, use, and disposal—results in the release of toxic, chlorine based chemicals. These toxins are building up in the water, air and food chain [resulting in] severe health problems, including cancer, immune system damage, and hormone disruption.” (Greenpeace®)

When considering the size of some types of sequins (which can be below 5 mm in diameter) they fall under the category of micro-plastics along with micro-beads found in cosmetics and glitter. “Micro-plastics are tiny pieces of plastic. The definition of their size varies in different studies, however most commonly they are defined as 5 millimetres at their largest.” (Ellen Macarthur Foundation®)

“Studies have shown the negative impacts of small plastic particles, mainly due to them being digested by aquatic organisms throughout the food chain. Ingestion of microplastics has been demonstrated to cause starvation and stunted growth in some species, and to have the ability to release substances of concern by breaking down in the digestive system” (Ellen Macarthur Foundation®). “This ubiquitous contamination of the ocean by micro-plastics, without a clear understanding of the long-term impacts, is becoming a major concern. Given the magnitude of this global ocean contamination, some refer to the current period of human activity not as the Anthropocene, but as the Plasticine, and describe the world's ocean as a ‘plastic soup’.”

Current attempts to create more sustainable sequins include the limited creation of cellulose sequins by Langlois-Martin products (https://www.pailletteslangloismartin.fr/en/home-page/) and sequins made from waste food (http://www.alicepotts.com/bioplastic.html and https://cqstudio.uk/materialsprojects/excessories-c534m). Langlois-Martin create sequins from cellulose acetate derived from a transformation of cotton or wood fibres (80% of the composition) added to solvents (20%) which evaporate mainly during the process. The Sustainable Sequin Company also make sequins from recycled polyester and are seeking to create sequins from compostable bioplastics (https://futurefashionfactory.org/a-new-solution-for sustainable-sequins/).

Meert et al, ‘Taking a shine to it: How the preference for glossy stems from an innate need for water’ JCP 2014, from Ghent University in Belgium found through a series of experiments, “that the preference for glossy and shiny stems from an innate need for water as a resource.” The desire for shiny and vibrant colourful effects is more deeply rooted in our human instincts, and therefore is an essential ingredient of countless industry products (packaging/cosmetics/textiles/coatings/automotive). These shiny materials come in many forms beyond sequins, such as components, glitter, confetti, pigments, paints, inks, coatings, foils and sheets. Industries need a sustainably sourced, circular, biodegradable and recyclable alternatives to plastics and metals to continue offering consumers colourful effects whilst aligning with UN-Sustainable Development Goals and emerging environmental policies.

U.S. Pat. No. 5,629,055 A describes solid films with novel optical properties which were produced from colloidal suspensions of cellulose crystallites.

Cellulose nanocrystals are rod shaped nanoparticles extracted from cellulose. Cellulose nanoparticles can be dispersed in water leading to the production of a chiral nematic liquid crystal, these structures can be preserved into the solid state. This nano architecture or micro structure can reflect light in the visible spectrum to produce structural colour.

Zhao et al “Printing of Responsive Photonic Cellulose Nanocrystal Microfilm Arrays' Adv. Funct. Mater. 2018, describes a study on the production of coatings using cellulose nanocrystals through a blade coating technique. The SEMs of the edge Zhao et al describes show a gradual decrease in thickness towards the edge of the membrane. However, in a highly ordered film, the edge effect observed by Zhao et al would result in observed structural colour decreasing in intensity relative to the thickness decreasing as the perimeter is approached, as the cholesteric axis remains perpendicular to the substrate.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

According to a first aspect of the invention, there is provided a membrane formed of a self-assembled microstructure of anisotropic nanocrystals and having a centroid and a perimeter, wherein around a majority of the perimeter the membrane curves back on itself.

The perimeter may correspond to the outline of a projection of the membrane onto a plane perpendicular to the thickness of the membrane at the centroid.

The membrane does not enclose a volume. The membrane may curve back on itself in a cross-sectional plane parallel to the membrane thickness at the corresponding point of the perimeter. The membrane may curve back on itself by a distance at least equal to 0.1 times the thickness of the membrane at the centroid. The membrane may curve back on itself by a distance at least equal to 0.2 times the thickness of the membrane at the centroid. The membrane may curve back on itself by a distance at least equal to 0.5 times the thickness of the membrane at the centroid.

In this way, a sharp or thin edge may be avoided at the perimeter. Consequently, crack initiation/propagation may be suppressed at the perimeter (which in many loading scenarios may correspond to maximum stress). This edge effect creates a membrane that may be less susceptible to breaking or cracking than previous membranes formed of a self-assembled microstructure of anisotropic nanocrystals. The curved-back (or “re-curved”) portion may still terminate with a sharp/thin edge.

The membrane of the first aspect may include features corresponding to any features of the method of the sixth aspect. Definitions applicable to the method of the sixth aspect (or features thereof) may be equally applicable to the membrane of the first aspect (or features thereof).

According to a second aspect of the invention, there is provided a membrane formed of a self-assembled microstructure of anisotropic nanocrystals and having an upper surface, a lower surface, a centroid and a perimeter, wherein moving from the upper surface to the lower surface around any point on the perimeter, a minimum radius of curvature is at least 0.1 times the thickness of the membrane at the centroid.

The perimeter may correspond to the outline of a projection of the membrane onto a plane perpendicular to the thickness of the membrane at the centroid.

In the same way as for the membrane of the first aspect, in the membrane of the second aspect a sharp or thin edge may be avoided at the perimeter. Consequently, crack initiation/propagation may be suppressed at the perimeter (which in many loading scenarios may correspond to maximum stress). This edge effect creates an membrane that may be less susceptible to breaking or cracking than previous membranes formed of a self-assembled microstructure of anisotropic nanocrystals.

The membrane of the second aspect may include features corresponding to any features of the method of the sixth aspect. Definitions applicable to the method of the sixth aspect (or features thereof) may be equally applicable to the membrane of the second aspect (or features thereof).

The following optional features are equally applicable to the membrane of the first aspect and/or the membrane of the second aspect (and/or articles containing either membrane).

The anisotropic nanocrystals may have a volume fraction of at least 70 wt % of the self-assembled microstructure. The anisotropic nanocrystals may have a volume fraction of at least 80 wt % of the self-assembled microstructure. The anisotropic nanocrystals may have a volume fraction of at least 90 wt % of the self-assembled microstructure. The anisotropic nanocrystals may be homogenously distributed throughout the volume of the membrane.

The membrane may have been formed as a single piece by drying of a suspension comprising the anisotropic nanocrystals. The origination of the membrane as having been formed as a single piece by drying of the suspension comprising the anisotropic nanocrystals may be determined from examination of the directional alignments of the anisotropic nanocrystals. Such directional alignments may be determined in a number of ways, including but not limited to:
Microscopy of fracture surfaces;
Microscopy of cross-sections (for example polished); or
When the membrane is at least partly transparent, by examination of the membrane using visible light between crossed polarizers.

In the case that edge-effects in the directional alignments of the anisotropic nanocrystals are substantially similar heading from any point on the perimeter towards the centroid, the membrane has been formed as a single piece by drying of the suspension comprising the anisotropic nanocrystals. When this is not the case, this indicates that a membrane has been cut from a larger object (in doing so, removing some edge-effected regions).

The membrane may have been formed by drying within a mould. The mould may be flexible, for example formed of silicone rubber. The mould may be rigid. The mould may be formed by embossing a surface. The mould may be formed by de-bossing a surface. Alternatively, the membrane may have been formed on a 2D mould in the form of a flat surface having regions which the suspension may wet defined by surrounding regions which the suspension may not wet. For example, when the suspension is aqueous, the 2D mould may include hydrophilic regions upon which the suspension is applied to form the membrane by drying, surrounded by hydrophobic regions which define the perimeter of the membrane.

The self-assembled microstructure of anisotropic nanocrystals may exhibit structural colour.

The self-assembled microstructure of anisotropic organic nanocrystals may have a pitch in the visible wavelength range, ~400-700 nm, and may exhibit structural colour. The self-assembled microstructure of anisotropic organic nanocrystals may have a pitch in the near infra-red and infra-red wavelengths, ~700-1000 nm, reflecting these wavelengths of light. The self-assembled microstructure of anisotropic organic nanocrystals may have a pitch in the UV and near UV wavelength range, infra-red, reflecting back these wavelengths of light.

The self-assembled microstructure of anisotropic nanocrystals may include one or more pigments. Herein the term pigments also encompasses dyes. The membrane may comprise a mixture or blend of two or more pigments. Pigments may be inorganic or organic. The membrane may have a colouring partly produced by structural colour from the self-assembled microstructure of anisotropic nanocrystals and partly by one or more pigments. Any or all of the pigments may be comprised in the anisotropic nanocrystals. Any or all of the pigments may be outside the anisotropic nanocrystals, for example in an additive constituent.

Alternatively, when the membrane comprises one or more pigments, the self-assembled microstructure of anisotropic nanocrystals may not exhibit structural colour.

The self-assembled microstructure of anisotropic nanocrystals may include one or more additives. The one or more additives may comprise a plasticizer. The one or more additives may include sorbitol, preferably sorbitol. The one or more additives may comprise a cross-linking agent. The additive may comprise a high contrast absorber such as, for example, carbon black, graphite, graphene or graphene oxide.

The one or more additives may include oils. The one or more additives may include waxes. Oils or waxes may be distributed within the self-assembled microstructure of anisotropic nanocrystals. Oils or waxes may form, or be applied as, a coating of the membrane. Oils or waxes may be encapsulated by another material or cell. Oils may be synthetic or natural, for example, vegetable oils, seed oils, silica based oil and so forth. Waxes may be synthetic or natural, for example, paraffin, rice bran wax, bees wax, carnuba wax and so forth.

The one or more additives may include at least one type of inorganic particle.

The one or more additives may include fibres. The fibres may be cellulose fibres and the anisotropic nanocrystals may be cellulose nanocrystals.

The one or more additives may include at least one polymer. The polymer may be a biopolymer. The polymer may function as a plasticizer. The polymer may function to provide cross-links between the anisotropic nanocrystals. The polymer may take the form of a matrix within which the anisotropic nanocrystals are embedded. The polymer may have the same monomer unit(s) as the anisotropic nanocrystals.

The membrane may be mechanically self-supporting. The membrane may not be supported on a substrate. In other words, the membrane may be freestanding.

The membrane may include one or more through-holes. A through-hole may be circular. Alternatively, a through-hole may be square, rectangular, or any other regular or irregular shape. The though-hole may be integrally formed at the time of forming the membrane, not cut, drilled or punched after formation of the membrane.

The self-assembled microstructure of anisotropic nanocrystals may reflect light at a target wavelength. The properties and distributions of the anisotropic nanocrystals, and the formation of the self-assembled microstructure, may have been controlled to result in a spacing of anisotropic nanocrystals which couples to light at a target wavelength by diffraction. The target wavelength may be within visible wavelengths. The target wavelength may be within infra-red wavelengths. The target wavelength may be within at UV wavelengths.

The anisotropic nanocrystals may be organic. The anisotropic nanocrystals may be inorganic.

The anisotropic nanocrystals may be formed of a biopolymer. The membrane may be biodegradable. The anisotropic nanocrystals may be biodegradable. The membrane may be compostable. The membrane may be recyclable.

The anisotropic nanocrystals may be cellulose nanocrystals. The anisotropic nanocrystals may be bacterial cellulose nanocrystals. The anisotropic nanocrystals may be neutralised cellulose nanocrystals. The anisotropic nanocrystals may be chitin nanocrystals. The anisotropic nanocrystals may be silica nanocrystals. The anisotropic nanocrystals may be silicon nanocrystals. The anisotropic nanocrystals may be silica/silicon nanocrystals. The anisotropic nanocrystals may be polystyrene. The anisotropic nanocrystals may be a mixture of the preceding materials.

The membrane may have a shape which is a circle, an oval, a triangle, a square, a rectangle, or any other regular or irregular shape. The membrane may have a shape corresponding to a letter, number, symbol, logo and so forth.

The membrane may be generally planar or film-like. The membrane may have a shape of a film conformed to the surface of a three-dimensional shape. For example, formed by drying of a suspension of the anisotropic nanocrystals within a mould having the corresponding shape.

An article may include the membrane of the first or second aspects, supported on a substrate. The substrate may be a film. The substrate may be a sheet. The substrate may be a plate. The substrate may be a surface of a three-dimensional object. The substrate may be a second membrane of the same type. The substrate may be a porous material. The porosity may be closed cell. The porosity may be open cell.

The substrate may include, or be formed from, a polymer, for example polylactic acid, alginates, polycaprolactone, cellulose acetate, and other biopolymers. The substrate may include, or take the form of, paper or card. The substrate may include, or take the form of, a fabric. A fabric may be synthetic, natural, non-woven or woven, for example, cotton, linen, hemp, viscose, lyocell, modal, silk, leather, chiffon, rayon, elastane, nylon and mixed fabrics. The substrate may include, or take the form of, a fibrous mat. The substrate may include, or take the form of, a laminate. The substrate may include or take the form of, a metal. The substrate may include or take the form of, a glass.

An article may include the membrane of the first or second aspects, bonded between a first layer and a second layer. The article may take the form of a laminate. The first layer may take any form described hereinbefore in relation to the substrate. The second layer may take any form described hereinbefore in relation to the substrate. The first and second layers may be formed of the same material. The first and second layers may be formed of different materials.

An article may include the membrane of the first or second aspects, and may also include a coating covering at least one surface of the membrane. The coating may provide a barrier layer protecting the self-assembled microstructure of anisotropic nanocrystals from moisture and/or other environmental factors. The coating may modify or augment mechanical properties of the membrane, for example by increasing rigidity, by filling in cracks and so forth. The surface of the membrane not covered by the coating may be bonded to, or supported on, the substrate described hereinbefore.

The coating may encapsulate a majority of the surface of the membrane. The coating may encapsulate at least 90% of the surface of the membrane. The coating may encapsulate the whole surface of the membrane.

An article may include the membrane of the first or second aspects, embedded in a transparent material. For example, the membrane may be embedded in a transparent epoxy.

Membranes according to the first and/or second aspect, or articles comprising the membranes, may be used to provide, without being limited to, sequins, glitter, jewels, gems, jewellery, costume jewellery, pendants, pieces to colour, ear pendants, buttons, stickers, spangles, rhinestones, hot fix crystals, embellishments, beads, nail art, glass stickers, decorative coating, confetti, tags, tokens, tinsil, or any other types of object used or applied to provide specular reflection, sparkle, metallic colour, brilliant colour, metallic shine pearlescent, holographic, iridescence or similar effects to an object.

Membranes according to the first and/or second aspect, or articles comprising the membranes, may also be used to provide, without being limited to, puzzle pieces, coasters, poker chips, trading cards, game pieces and so forth.

Membranes according to the first and/or second aspect, or articles comprising the membranes, may be applied to fabrics or other surfaces by applying the suspension comprising the anisotropic nanocrystals using a screen printing process, a dot-matrix printing process, an inkjet printing process, a flexographic printing process, a gravure printing process, a lithographic printing process and so forth.

Membranes according to the first and/or second aspect, or articles comprising the membranes, may be used as a replacement for foiling of fabrics, paper, card and so forth.

According to a third aspect of the invention, there is provided a method of forming a membrane, including dispensing a volume of a suspension into a mould or onto a template. The suspension including a suspension of anisotropic nanocrystals in a solvent. The method also includes allowing the dispensed suspension to dry to form a membrane having a self-assembled microstructure of the anisotropic nanocrystals and having a centroid and a perimeter, wherein around a majority of the perimeter the membrane curves back on itself.

The method of the third aspect may include features corresponding to any features of membranes of the first and/or second aspects, or articles containing said membrane(s). Definitions applicable to the membranes of the first and/or second aspects (or features thereof) may be equally applicable to the method of the third aspect (or features thereof).

The method of the third aspect may include features corresponding to any features of the method of the sixth aspect. Definitions applicable to the method of the sixth aspect (or features thereof) may be equally applicable to the method of the third aspect (or features thereof).

According to a fourth aspect of the invention, there is provided a method of forming a membrane, including dispensing a volume of a suspension into a mould or onto a template. The suspension including a suspension of anisotropic nanocrystals in a solvent. The method also includes allowing the dispensed suspension to dry to form a membrane having a self-assembled microstructure of the anisotropic nanocrystals and having an upper surface, a lower surface, a centroid and a perimeter, wherein moving from the upper surface to the lower surface around any point on the perimeter, a minimum radius of curvature is at least 0.1 times the thickness of the membrane at the centroid.

The method of the fourth aspect may include features corresponding to any features of membranes of the first and/or second aspects, or articles containing said membrane(s). Definitions applicable to the membranes of the first and/or second aspects (or features thereof) may be equally applicable to the method of the fourth aspect (or features thereof).

The method of the fourth aspect may include features corresponding to any features of the method of the sixth aspect. Definitions applicable to the method of the sixth aspect (or features thereof) may be equally applicable to the method of the fourth aspect (or features thereof).

The following optional features are equally applicable to the method of the third aspect and the method of the fourth aspect.

The method may include dispensing a volume into each of two or more moulds disposed to form an array. All of the moulds may be identical, although is this is not essential. When the moulds are not identical, different volumes of suspension may be dispensed corresponding to each different type, shape or volume of mould.

The method may include dispensing a volume one each of two or more templates disposed to form an array. All of the templates may be identical, although is this is not essential. When the templates are not identical, different volumes of suspension may be dispensed corresponding to each different type or shape of template.

The volume of suspension may be dispensed into a mould having walls with a height of less than or equal to 3 mm. The volume of suspension dispensed may be greater than a volume contained up to the wall height of the mould. In other words, the mould may be overfilled. Surface tension may prevent the dispensed volume from overflowing the mould, and may keep the suspension pinned to the mould area.

The mould may be flexible. The mould may be formed of silicone rubber. Alternatively, the mould may be rigid.

The mould may be formed of any material having a surface energy with the anisotropic nanocrystals such that formation of the self-assembled microstructure is energetically preferred at the air-suspension-mould interface (edge/1-D interface), relative to the suspension-mould interface (surface/2-D interface). The mould may be formed of any material having a poor adhesion to the self-assembled microstructure of the anisotropic nanocrystals, for example a contact angle of greater than or equal to 50°

The volume of suspension may be dispensed into a mould or template formed by embossing or debossing a first substrate.

The first substrate may be formed of any material having a surface energy with the anisotropic nanocrystals such that formation of the self-assembled microstructure is energetically preferred at the air-suspension-second substrate interface (edge/1-D interface), relative to the suspension-second substrate interface (surface/2-D interface). The first substrate may be formed of any material having a poor adhesion to the self-assembled microstructure of the anisotropic nanocrystals, for example a contact angle of greater than or equal to 50°.

The first substrate may be a film. The first substrate may be a sheet. The first substrate may be a plate. The first substrate may be a surface of a three-dimensional object. The first substrate may be a second membrane of the same type. The first substrate may be a porous material. The porosity may be closed cell. The porosity may be open cell.

The first substrate may include, or be formed from, a polymer. The first substrate may include, or take the form of, paper or card. The first substrate may include, or take the form of, a fabric. The first substrate may include, or take the form of, a fibrous mat. The first substrate may include, or take the form of, a laminate. The first substrate may include or take the form of, a metal. The substrate may include or take the form of, a glass.

The volume of suspension may be dispensed into a template comprising a first region of a second substrate which the suspension will wet, surrounded and defined by a second region which the suspension will not wet.

The suspension may be considered to wet a region if the contact angle of a drop of the suspension on that region is less than or equal to 90°. The suspension may be considered to not wet a region if the contact angle of a drop of the suspension on that region is greater than 90°.

For example, when the suspension is aqueous, the 2D mould may include hydrophilic regions upon which the suspension is applied to form the membrane by drying, surrounded by hydrophobic regions which define the perimeter of the membrane.

The second substrate may be formed of any material having a surface energy with the anisotropic nanocrystals such that formation of the self-assembled microstructure is energetically preferred at the air-suspension-second substrate interface (edge/1-D interface), relative to the suspension-second substrate interface (surface/2-D interface). The second substrate may be formed of any material having a poor adhesion to the self-assembled microstructure of the anisotropic nanocrystals, for example a contact angle of greater than or equal to 50°.

The second substrate may be a film. The second substrate may be a sheet. The second substrate may be a plate. The second substrate may be a surface of a three-dimensional object. The second substrate may be a second membrane of the same type. The second substrate may be a porous material. The porosity may be closed cell. The porosity may be open cell.

The second substrate may include, or be formed from, a polymer. The second substrate may include, or take the form of, paper or card. The second substrate may include, or take the form of, a fabric. The second substrate may include, or take the form of, a fibrous mat. The second substrate may include, or take the form of, a laminate. The second substrate may include or take the form of, a metal. The substrate may include or take the form of, a glass.

The suspension may include one or more pigments. The suspension may include a mixture or blend of two or more pigments. Pigments may be inorganic or organic. The resulting membrane may have a colouring partly produced by structural colour from the self-assembled microstructure of anisotropic nanocrystals and partly by one or more pigments. Any or all of the pigments may be comprised in the anisotropic nanocrystals. Any or all of the pigments may be outside the anisotropic nanocrystals, for example in an additive constituent.

The suspension may include one or more additives. The one or more additives may comprise a plasticizer. The one or more additives may include sorbitol, preferably sorbitol. The one or more additives may comprise a cross-linking agent. The one or more additives may include a high contrast absorber such as, for example, carbon black, or black algae, graphite, graphene and so forth.

The one or more additives may include at least one type of inorganic particle.

The one or more additives may include oils. The one or more additives may include waxes. Oils or waxes may be distributed within the self-assembled microstructure of anisotropic nanocrystals. Oils or waxes may form, or be applied as, a coating of the membrane. Oils or waxes may be encapsulated by another material or cell. Oils may be synthetic or natural, for example, vegetable oils, seed oils, silica based oil and so forth. Waxes may be synthetic or natural, for example, paraffin, rice bran wax, bees wax, carnuba wax and so forth.

The one or more additives may include fibres. The fibres may be cellulose fibres and the anisotropic nanocrystals may be cellulose nanocrystals.

The one or more additives may include at least one polymer. The polymer may function as a plasticizer. The polymer may function to provide cross-links between the anisotropic nanocrystals. The polymer may take the form of a matrix within which the anisotropic nanocrystals are embedded. The polymer may have the same monomer unit(s) as the anisotropic nanocrystals.

The one or more additives may include two or more polymer pre-cursors which react in the suspension to form a polymer. One or more of the polymer pre-cursors may be added to the suspension immediately prior to dispensing the suspension into the mould or onto the template. The polymer pre-cursors may react to form the polymer in parallel with drying of the suspension.

The mould or the template may also include one or more through-hole structures arranged to cause the resulting membrane to comprise a through hole corresponding to each through-hole structure. A through-hole structure may be circular.

Alternatively, a through-hole structure may be square, rectangular, or any other regular or irregular shape.

The anisotropic nanocrystals may be formed of a biopolymer.

The membrane may be biodegradable. The membrane may be compostable. The anisotropic nanocrystals may be biodegradable.

The anisotropic nanocrystals may be cellulose nanocrystals. The anisotropic nanocrystals may be bacterial cellulose nanocrystals. The anisotropic nanocrystals may be neutralised cellulose nanocrystals. The anisotropic nanocrystals may be chitin nanocrystals. The anisotropic nanocrystals may be silica nanocrystals. The anisotropic nanocrystals may be silicon nanocrystals. The anisotropic nanocrystals may be silica/silicon nanocrystals. The anisotropic nanocrystals may be polystyrene. The anisotropic nanocrystals may be a mixture of the preceding materials.

The suspension may be an aqueous suspension comprising 2 wt % cellulose nanocrystals.

The temperature may be maintained between 18° C. to 25° C. during drying of the suspension.

the humidity may be maintained between 48% and 65% during drying of the suspension.

The method may also include subjecting the dispensed suspension to a constant, even, airflow.

The method may also include subjecting the dispensed suspension to a patterned or un-patterned electric field, during drying. When the suspension exhibits liquid crystal properties, the anisotropic nanocrystals may locally align with the electric field, leading to controllable patterns in the structural colour of the membrane.

The membrane may be releasable from the mould or template. The method may also include removing the dried membrane from the mould or template.

The membrane may be dried, and may remain adhered to a third substrate. The third substrate may be received into the mould before dispensing the suspension. The template may include, or take the form of, the third substrate.

The third substrate may be a film. The third substrate may be a sheet. The third substrate may be a plate. The third substrate may be a surface of a three-dimensional object. The third substrate may be a second membrane of the same type. The third substrate may be a porous material. The porosity may be closed cell. The porosity may be open cell.

The third substrate may include, or be formed from, a polymer, for example Polylactic acid, alginates, polycaprolactone, cellulose acetate, and other biopolymers. The third substrate may include, or take the form of, paper or card. The third substrate may include, or take the form of, a fabric. Fabrics may be synthetic, natural, non-woven and woven, for example, cotton, linen, hemp, viscose, lyocell, modal, silk, leather, chiffon, rayon, elastane, nylon and mixed fabrics. The third substrate may include, or take the form of, a fibrous mat. The substrate may include, or take the form of, a laminate.

According to a fifth aspect of the invention, there is provided a method including wetting a membrane according to the first or second aspects (and/or produced according to the method of the third or fourth aspect) using a second solvent. The method also includes placing the membrane in contact with a surface of an object. The method also includes allowing the second solvent to dry such that the membrane becomes adhered to the surface of the object.

The second solvent may be the same solvent as was used in a suspension dried to form the membrane.

The method of the fifth aspect may include features corresponding to any features of membranes of the first and/or second aspects, or articles containing said membrane(s). Definitions applicable to the membranes of the first and/or second aspects (or features thereof) may be equally applicable to the method of the fifth aspect (or features thereof).

The method of the fifth aspect may include features corresponding to any features of methods of the third and/or fourth aspects. Definitions applicable to the methods of the third and/or fourth aspects (or features thereof) may be equally applicable to the method of the fifth aspect (or features thereof).

The method of the fifth aspect may include features corresponding to any features of the method of the sixth aspect. Definitions applicable to the method of the sixth aspect (or features thereof) may be equally applicable to the method of the fifth aspect (or features thereof).

In contrast to conventional techniques for producing sequins, the sequins of the present disclosure are made using cellulose nanocrystals (CNC) which results in structural colourations due to the way in which the CNC assembles as it dries. This means that a luster and colour vibrance can be achieved that does not require the use of pigments, minerals or metals, resulting in a process that uses less resource-intensive materials.

Furthermore, it means that the sequins of the present disclosure may be biodegradable.

Furthermore, while pigments may be added for colour, these are not required to create iridescence. Eliminating the need for incorporating additional pigments is a benefit from both a formulation and cost standpoint. Embellishment components previously made using cellulose acetate (or other bio-plastics) require added colourants and sparkle agents. Furthermore, working with CNC, means non-toxic solvents (such as water) may be used as an evaporating substrate rather than toxic solvents.

Moreover, the sequins of the present disclosure may be made by casting in a mould rather than punching from a sheet material. By not punching from a sheet material this may reduce wastage (by up to 33% on average) as punched sequins leave behind a punctured sheet of material (sometimes referred to as Punchinella), that has no viable use.

Creating the sequins by casting in a mould has additional advantages. Using precision moulds gives form/shape to the CNC material as it self-assembles (as the cast liquid dries), creating a fully formed shape/component that is less brittle than when being cut or punched from a sheet material.

Accordingly, in a sixth aspect of the disclosure there is a method of manufacturing an iridescent sequin such as a biodegradable sequin. The method comprises obtaining a suspension of cellulose nanocrystals and a plasticizer dissolved in water, dispensing the suspension into a flexible mould, drying the dispensed suspension at a temperature of between 18° C. to 25° C. and relative humidity of between 48% and 65% to create dried iridescent sequins, and flexing the mould to release the dried iridescent biodegradable sequins from the mould. Preferably the drying time is at least 6 hours, preferably at least 8 hours. A drying time of 6 hours is preferred when the temperature is 25° C.

However, it will be understood that in some examples a flexible mould may not be used. In such examples the method accordingly would not comprise the step of flexing the mould to release the dried iridescent sequins from the mould. For example, instead the method may comprise some other technique for lifting the dried iridescent sequins from the mould—for example using suction/vacuum possibly in combination with a mechanism for releasing the upstanding rods (as referred to below)—for example the rods may be separate items that may be removable from the mould, such as pins or nails that extend through the mould, however generally it is preferred that the rod is the same material as the rest of the mould to avoid differences in surface tension which can result in undesirable structural properties (e.g., curving) of the sequins when dried.

Advantageously, fully forming the sequins in moulds as individual objects produces the individual circular colouration (bull's eye or coffee ring effect-see, for example, Klockars et al., Asymmetrical coffee rings from cellulose nanocrystals and prospects in art and design, Cellulose 26, 491-506 (2019)), which is natural to CNC self-assembly. This effect is unique in the field of sequin iridescent effects. In addition, this method of forming sequins still allows for CNC colouration effects such as such as single colours or two-tone shifting colours. Furthermore, creating a fully formed shape avoids cutting from a larger sheet and generating waste. In contrast to conventional sequins, biodegradable sequins of the present disclosure have sustainable sparkle, lustre, and vibrant non-fading colouration.

The mould preferably comprises a plurality of receptacles for receiving the suspension, and wherein each receptacle comprises an upstanding rod, made from the same material as the rest of the mould, for creating a hole in the sequin when dried. The rod is configured to create a hole in the sequin when dried to enable the sequin to be sewn/embroidered onto a garment or textile.

In some examples each of the receptacles is circular, although it will be understood that other geometric shapes may be used such as triangular or trapezoidal.

Each receptacle may be circular and have a flat base, with a diameter of 10 mm, a wall height or depth of 0.3-0.5 mm. The rod may have a diameter of between 0.8 to 1.5 mm, for example from 0.8 to 1.2 mm, and preferably 1.2 mm. 1.2 mm has surprisingly been found to be particularly effective in balancing the need for a hole to be created in the sequin vs the structural integrity of both the mould and the created sequin. In some examples the rod is 3 mm from the edge and/or 2 mm from the centre. For such dimensions preferably approximately 200 to 350, preferably 250 to 330 microliters of solution are dispensed into each receptacle (preferably more solution is dispensed into the receptacle than the volume of the receptacle so that the solution forms a domed surface due to surface tension effects.

This ensures that when the suspension dries it forms a flat sequin with enough structural integrity. It has been found that such dimensions create an even film/sequin without raised edges and without deformation around the rod/hole. However, it will be appreciated that other sized sequins may be made. For sequins with other dimensions, the relative dimensions of the components of the mould/receptacle may remain the same—for example the wall height or depth may remain at 0.3-0.5 mm even if the diameter of the sequin were reduced to 5 mm. Similarly, the rod may have the same diameter of 1.2 mm as a thread will need to pass through the resultant hole in the sequin for sewing/embroidering onto a garment—although of course the relative spacing of the rod from the centre and from the wall may differ.

The suspension may be dispensed into each of the receptacles of the mould adjacent to the rod. Advantageously and surprisingly, dispensing the solution adjacent to the rod means that CNC material self-assembles around the hole for sewing, avoiding punching a hole, as well as giving a circular iridescent pattern. Furthermore, it has been found that dispensing the solution adjacent to the rod also reduces the likelihood of air bubbles forming in the solution which would result in a defective sequin.

The suspension may be a suspension of 2 wt % cellulose nanocrystals. The plasticizer may comprise, for example, sorbitol and/or glycerol. The plasticizer may be at a ratio of 10% of the dry mass of the cellulose nanocrystals. These concentration of materials have been surprisingly found to create an even film/sequin with good colouration.

In some examples the suspension further comprises a cross-linking agent.

In some examples the suspension further comprises a colour dye. The dye may be a food dye, such as Food Colours 102, 122, (2.3% Total Dyestuff). The colourants were 122—a synthetic red colorant belonging to the group of azo dyes. It is obtained from coal tar and mostly used in the confectionery industry, and 102 Tartrazine—synthetic lemon yellow azo dye primarily used as a food colouring. Synthetic colourants may be used.

Preferably, a natural food colouring that is 100% natural and plant based may be used, for example a yellow colouring made from the extract of real Marigold petals may be used (comprising water, glycerin and marigold extract (1.5%)), or a green colouring for example made from glycerin and spinach extract (18.7%).

The concentration depends very much on the dye used and the concentration of the dyestuff to water. Preferably the concentration may be in the region of from about 0.6% to about 2.1% by volume. As a rough guide, 2 drops of dye (1 ml dye: 144 ml CNC), would be equal to around 0.69%, four drops of dye (2 ml dye: 144 ml CNC) would be equal to 1.39%, and six drops of dye (3 ml dye: 144 ml CNC) would be equal to 2.07%. Using beyond 10 drops (3.45%) could possibly change the CNC mixture too much and affect the assembly of the CNC as it dries to form the sequin.

The temperature for drying is preferably 23° C. The humidity for drying is preferably 50%. Such temperature and humidity have surprisingly been found to dry the sequins at a slow enough rate that an aesthetically pleasing iridescence is formed and the sequins do not dry too quickly and become too brittle.

In some examples the method may further comprise the step of coating the iridescent sequins in a cellulose material, such as cellulose acetate.

Drying the dispensed suspension may comprise subjecting the dispensed suspension to a constant, even, airflow. Advantageously this may help to ensure that all sequins in the 15 mould dry at the same time and rate.

In a seventh aspect of the disclosure there is an iridescent sequin made according to the method described above.

In an eighth aspect of the disclosure there is an iridescent sequin comprising cellulose nanocrystals and a plasticizer.

The plasticizer may be sorbitol. The plasticizer may be at a ratio of 10% of the dry mass of the cellulose nanocrystals.

The iridescent sequin may further comprise a cross-linking agent.

### BRIEF DESCRIPTION OF THE DRAWINGS

Embodiments of the disclosure will now be described, by way of example only, with reference to the accompanying drawings, in which:

FIG. 1 shows a perspective view of an example mould for sequins comprising dried sequins in each of the plurality of receptacles;

FIG. 2A shows another schematic view of the example mould for sequins of FIG. 1 without any sequins or suspension;

FIG. 2B shows a cross-section of the example mould for sequins of FIG. 2A; FIG. 2C shows an enlarged portion of the cross-section of FIG. 2B;

FIG. 2D shows a schematic view of a receptacle of the mould of FIGS. 1 to 2C;

FIG. 3 shows a perspective view of a robot dispensing a suspension into each of the receptacles of a mould, such as the mould of FIG. 1 or 2;

FIG. 4 shows a photo of example iridescent sequins manufactured according to embodiments of the disclosure;

FIG. 5 shows an example process flow diagram of an example method of making iridescent sequins;

FIG. 6 shows a plot of drying time and colour intensity against temperature;

FIG. 7 schematically illustrates forming a membrane by dispensing a suspension of anisotropic nanocrystals into a mould;

FIG. 8 schematically illustrates forming a membrane by dispensing a suspension of anisotropic nanocrystals onto a mould;

FIG. 9 schematically illustrates forming a membrane by dispensing a suspension of anisotropic nanocrystals into a mould formed by embossing a substrate;

FIG. 10 schematically illustrates forming a membrane by dispensing a suspension of anisotropic nanocrystals into a mould formed by debossing a substrate;

FIG. 11 is a schematic cross-section of a first type of membrane;

FIG. 12 is a schematic cross-section of a second type of membrane;

FIGS. 13A to 13G are schematic cross-sections of first to seventh examples of the first type of membrane;

FIGS. 14A to 14F are schematic cross-sections of first to sixth examples of the second type of membrane;

FIG. 15 pictures examples of membranes of the first type, and having a variety of shapes, between differently configured polarisers;

FIG. 16 presents a comparison of membranes formed according to the specification and shapes physically cut from a sheet having the same formulation, under the same conditions as FIG. 15;

FIGS. 17A to 17D present scanning electron microscope cross sections for example of the membrane of the first type;

FIG. 18 presents optical microscopy of a cellulose nanocrystal membrane of the first type from a range of observation angles between 0° and 50°;

FIG. 19 is a 3D optical image of the cellulose nanocrystal membrane shown in FIG. 18;

FIG. 20A is a photograph of a cellulose nanocrystal membrane of the second type;

FIG. 20B is a photograph of the cellulose nanocrystal membrane shown in FIG. 20A, broken in half to show the cross-section shape;

FIG. 21 presents a scanning electron microscope cross-section of a comparative example produced by drying a suspension of cellulose nanocrystals in a petri dish; and

FIG. 22 presents a scanning electron microscope cross-section of a cellulose nanocrystal membrane of the second type.

### DETAILED DESCRIPTION

Structural colour in the present disclosure is caused by a nanoarchitecture (also referred to as a microstructure) of nanoparticles which exhibits cholesteric order. This structure can be formed by the self-assembly of a chiral nematic liquid crystal. Once a critical concentration is reached of the nanoparticles under the optimum conditions, the nanoparticles start to form a cholesteric helicoidal microstructure. The particles form pseudo layers perpendicular to a cholesteric axis, parallel to the base substrate. The cholesteric pitch is defined by a rotation of director of these pseudo layers rotates 360°. When this pitch is within the visual spectrum, structural colour is observed.

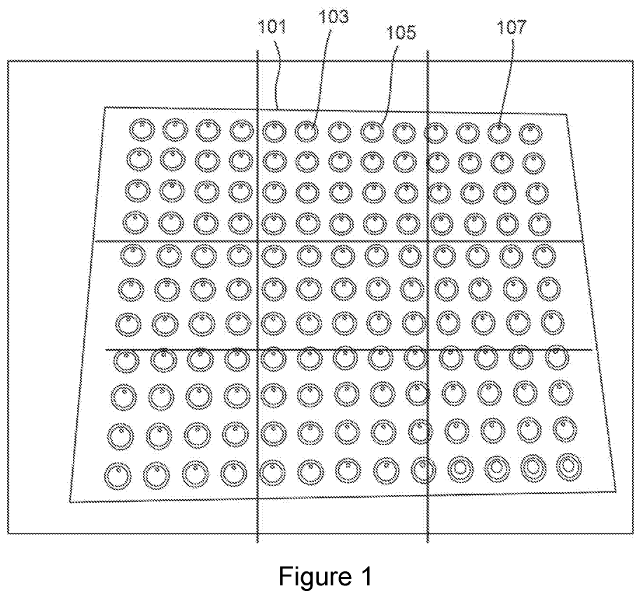

FIG. 1 shows perspective views of an example mould 101 for sequins comprising a suspension dispensed into each of a plurality of receptacles 103. FIG. 1 shows the mould 101 containing dried sequins.

In this example the mould 101 is made from a flexible material such as silicone. Silicone advantageously does not stick to the sequins when they have dried which facilitates their removal. While a release agent may be used, they have been found to lead to a “matt” surface finish within the mould which negatively affects the aesthetic properties of the sequins.

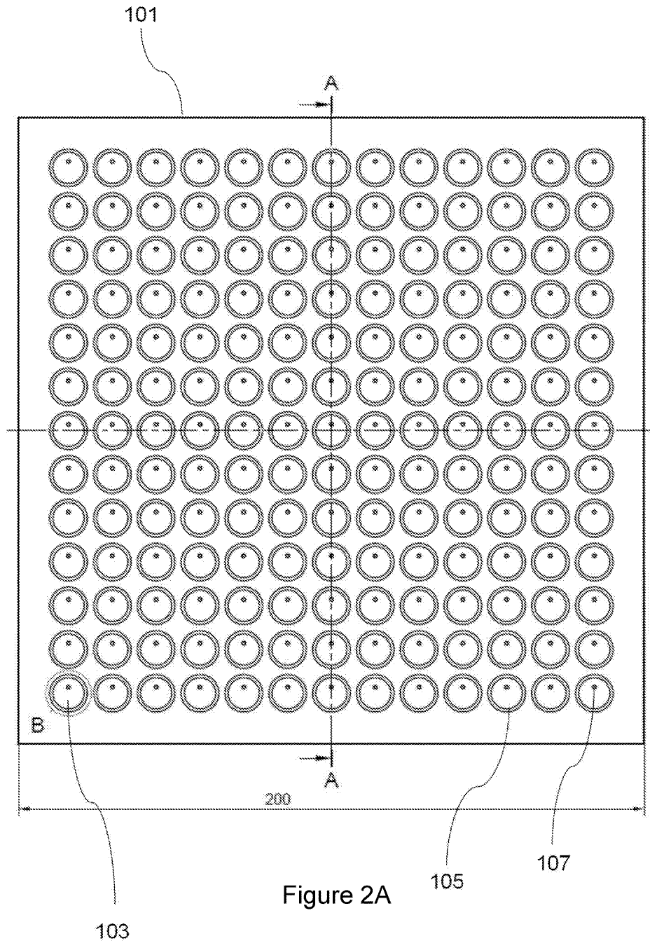

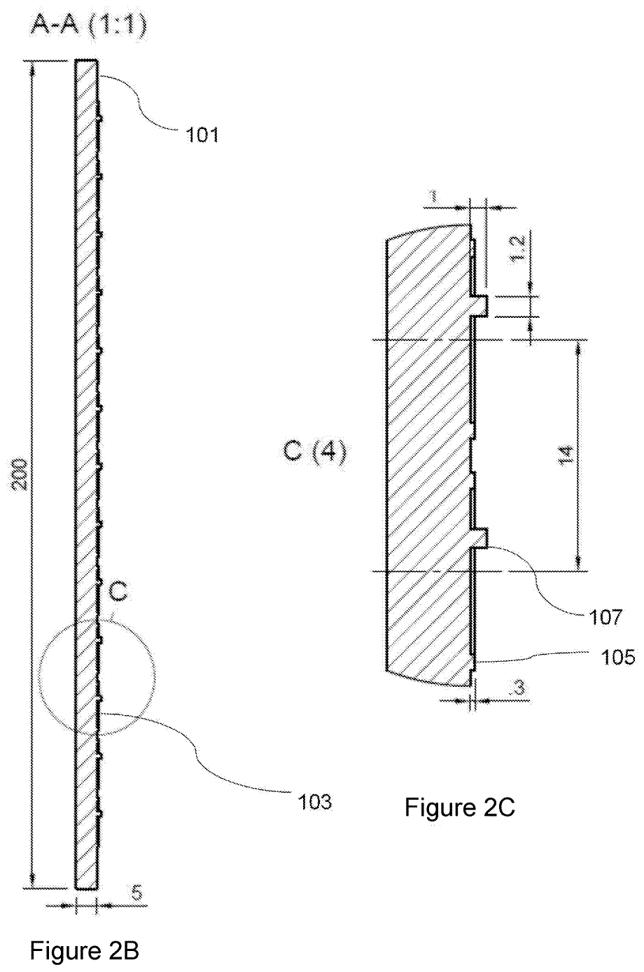

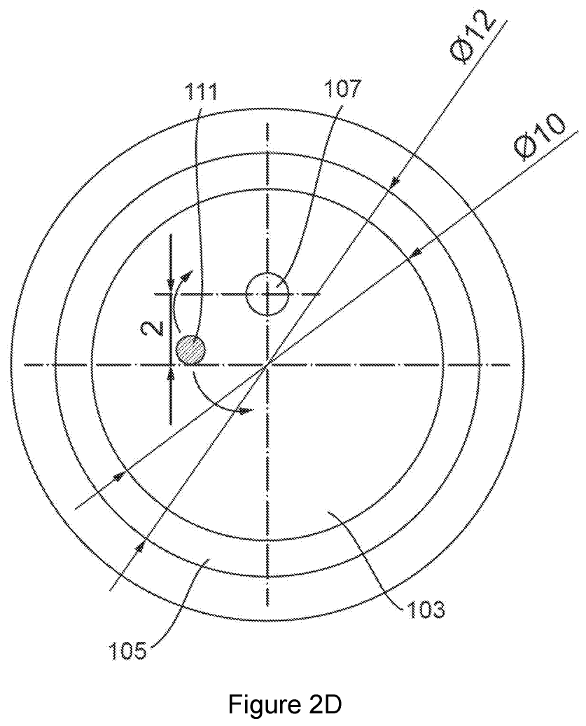

FIGS. 2A to 2D show a schematic view of the mould 101 and receptacles 103. Each of the receptacles 103 shown in FIGS. 1 to 2D are circular in shape, although as noted above other shaped receptacles may be used. The receptacle 101 is formed by a circular wall 105 that protrudes from the surface of the mould 101. In this example this creates a receptacle 103 that has a base level with the rest of the mould 101, however in other examples the base of the receptacle 103 may not be flat and/or level with the rest of the mould 101. For example, the base of the receptacle 103 may be indented or patterned to create a 3D sequin.

Inside the receptacle 103 there is a rod 107 also upstanding from the base and parallel to the wall 105 of the receptacle 103. In the example shown each receptacle 103 has a diameter of 10 mm, a wall height or depth of 0.3-0.5 mm and a wall thickness of 2 mm (the inside surface of the wall has a diameter of 10 mm, and the outside surface of the wall has a diameter of 12 mm). The rod 107 has a diameter of 1.2 mm and may be 3 mm from the edge and 2 mm from the centre, as shown in more detail in FIG. 2D. For a receptacle 103 of these dimensions, preferably approximately 300 to 330 microliters of solution is dispensed into each receptacle 103. Preferably more solution is dispensed than the volume of the receptable resulting in an initially domed liquid shape (due to the surface tension) Once the suspension is dried and the water evaporates this results in a flat sequin.

The mould 101 shown in FIGS. 1 and 2 has been made from Smooth-On Mold Star™ purchased from Bentley® Advanced Materials cast over an acrylic cast/die, which was machined using a computer-controlled CNC (computerized numerical control) machine.

In some examples vacuum degassing may be employed to remove air bubbles from the cast mould and also to ensure that the rods are formed precisely.

However, in some examples instead of using a mould made from silicone, a base layer that also acts as a mould may be used. The base layer and the CNC would then fuse, and a cutting die (designed to match the mould) would cut them out as one component. Here the aqueous CNC would still be able to evaporate and create the chiral structural coloured pattern in the mould.

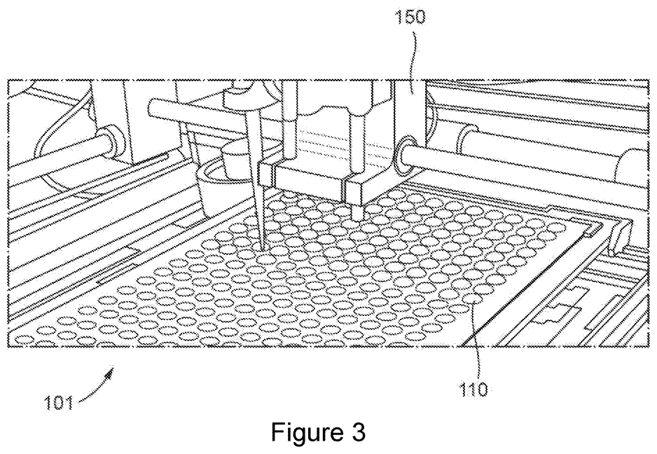

FIG. 3 shows a perspective view of a robot 150 dispensing a suspension into each of the receptacles 103 of a mould 101, such as the mould 101 of FIGS. 1 to 2D. The suspension contains cellulose nanocrystals (CNC) dissolves in a solvent, which in this case is water. The suspension may contain between 10 and 1 wt % cellulose nanocrystals. Preferably the suspension contains 2 wt % cellulose nanocrystals. A plasticizer is also added to the suspension and in this example is sorbitol. The plasticizer may be added at a ratio of 10% of the dry mass of the cellulose nanocrystals.

Cellulose nanocrystals from a variety of sources can be used, including nanocrystals produced via acid hydrolysis from a variety of cellulose material including (but not limited to) wood pulp, filter paper, cotton, waste cellulose sources. Cellulose nanocrystals are available to be purchased from commercial suppliers.

An example of cellulose nanocrystals that may be used are CelluForce NCC® NCV100NASD90. These cellulose nanocrystals are extracted from cellulose, the main building block of trees and plants, and is a re-dispersible powder of uniform acyclic nanometric crystals. Their size, shape, and charge lead to unique behaviour in suspensions. The high chemical reactivity of the crystal surfaces makes CelluForce NCC® customizable for various applications. Properties of the cellulose nanocrystals are provided in Table 1 below.

TABLE 1
Characteristics of example CNC material

| Product Form | | Spray dried powder |
|---|---|---|
| Appearance (colour) | | White to Off-White Powder |
| Density | g · cm − 3 | 0.4-0.6 |
| Moisture content | wt. % | ≤6 |
| Particle Size (powder) | μm | 1-50 |
| Particle size1 | nm | <150 |
| Conductivity1 | μS · cm − 1 | <350 |
| pH | | 5.0-8.0 |

As shown in FIG. 3, the suspension is dispensed using a custom-built dispensing robot. The dispensing robot is configured to dispense a selected volume of liquid into each receptacle.

For a receptacle 103 having a diameter of 10 mm and a wall height or depth of 0.30.5 mm preferably 300 UL of suspension are delivered or dispensed into each receptacle. Due to the surface tension of the suspension, as can be seen in FIG. 3 this results in a domed “bubble” of liquid suspension 110 in each receptacle 103. However, as the water evaporates from the suspension during the drying process this domed bubble 110 reduces in size and results in a generally flat solid iridescent sequin. FIG. 2B shows a cross-section of the receptacles 103 of the mould 101 filled with solution.

The suspension may preferably be dispensed into each of the receptacles 103 of the mould 101 adjacent to the rod 107, as shown in FIG. 2D as preferred dispensing location 111. In the example shown, if the rod 107 is taken as being on the y axis from the centreline, then the preferred dispensing location 111 is approximately 1 mm from the centreline of the receptacle 103 in the x axis and 3 mm from the rod 107 in the y axis.

Advantageously and surprisingly, dispensing the solution adjacent to the rod means that CNC material self-assembles around the hole for sewing, avoiding punching a hole, as well as giving a circular iridescent pattern. Furthermore, it has been found that dispensing the solution adjacent to the rod also reduces the likelihood of air bubbles forming in the solution which would result in a defective sequin.

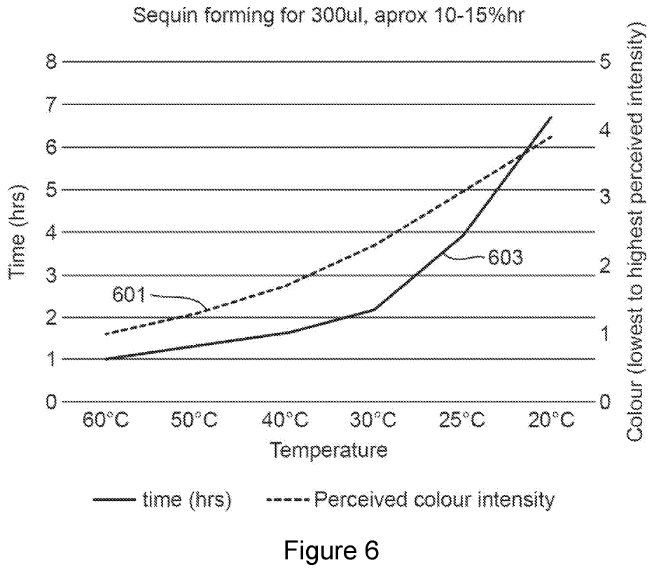

Once all of the receptacles 103 of a mould 101 have been filled, the mould 101 is subjected to a drying process. The drying process is controlled so as to not be too rapid, which would result in sequins having poor iridescence and also potentially being more brittle. This is described in more detail below with reference to FIG. 6.

It has been found that preferably the sequins should be dried at ambient temperature, for example at room temperatures between 15° to 25° C., preferably 22° C. to 23° C., and even more preferably 23° C. Preferably the humidity should be kept constant at 48% to 65% and preferably at 50%. Optionally an even airflow may be delivered over the top of the mould 101 to enhance drying, but it is important that the airflow is even as it has been found that without an even airflow the humidity in the centre of the mould 101 may be higher and cause the sequins at the edges of the mould 101 to dry more quickly and thereby have a different quality of iridescence compared to those made towards the centre of the mould 101. Having sequins of different quality of iridescence may not be acceptable for a fashion house where all the sequins on a garment must look identical.

Additionally, or alternatively, the moulds 101 may be dried by heating at 40° C., 105° C. and/or 65° C. and then pressing the dried sequin with a heat press at 200 bars. This flattened the sequins and showed improved hydrophobic properties, however, the sequins became more brittle during sewing.

Having flexible moulds 101 is desirable so that the sequins release easily when bending the mould by hand.

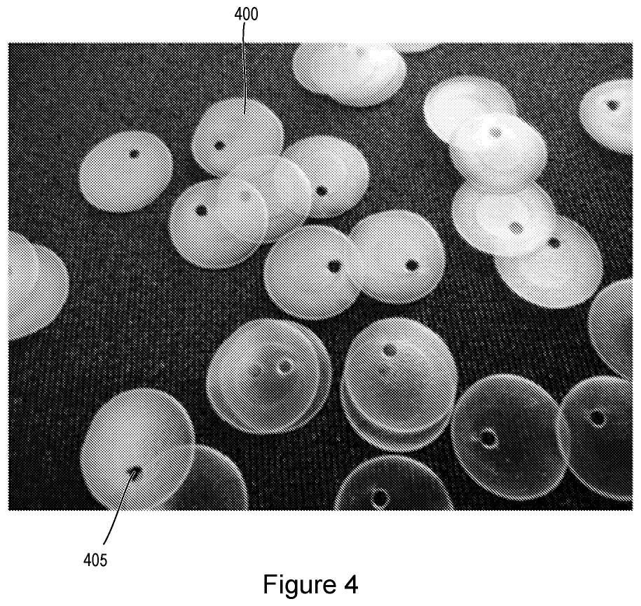

FIG. 4 shows a photo of example iridescent sequins 400 manufactured according to embodiments of the disclosure. As can be seen in FIG. 4, the iridescent sequins 400 have a natural circular iridescent pattern, caused by the self-assembly of the CNC suspension as it dries in the receptacles of the mould. The iridescent sequins 400 also have a hole 405 formed by the rods 107 in each receptacle 103. The hole 405 advantageously enables a thread to be passed therethrough so that the sequin may be sewn onto a textile or garment.

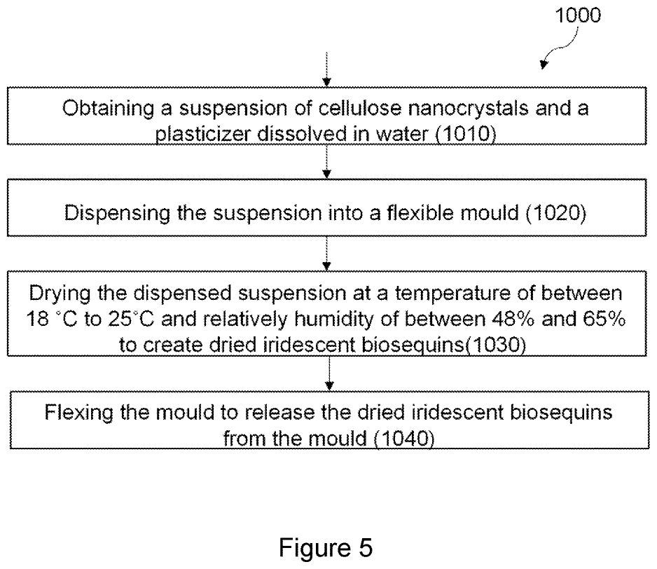

FIG. 5 shows an example process flow diagram of an example method 1000 of making iridescent sequins. At step 1010 a suspension of cellulose nanocrystals and a plasticizer dissolved in water are obtained. At step 1020 the suspension is dispensed into a flexible mould. At step 1030 the dispensed suspension is dried at a temperature of between 18° C. to 25° C. and relatively humidity of between 48% and 65% to create dried iridescent sequins. At step 1040 the mould 101 is flexed to release the dried iridescent sequins from the mould 101.

In some examples the brittleness of the sequins may be improved by adding an additive, synthetic polymer, or plastics.

In some examples instead of forming the sequins in mould, a sheet of CNC material may be formed with a roll-to-roll method and the sequins manufactured using a traditional punching method. However, this would still have waste, and the material might not meet the mechanical properties needed to withstand the impact of the punching machine.

In some examples instead of forming the sequins in mould 101, a pre-existing or new formulation of a cellulose plastic sheet (which may be washable) may be used and coated with coloured metal (such as aluminium). This option would not reduce the use of coloured pigments or metals and would be more resource intensive than the method described above with reference to FIGS. 1 to 5.

Another way of forming sequins could be to layer cellulose film (probably fibrillated cellulose for mechanical properties, not crystalline) where the layers are at a specific distance selected so that they refract light and create structural colours. This would make an all-over colouration effect. To mimic the colouration achieved in the iridescent sequins described above with reference to FIGS. 1 to 5, the film may be inkjet printed with a pigment colour to get the colour rings, or to create structural colours, maybe magnets could create a pattern. This would then have to be printed to match to the die-cutting tool.

As described above, if the sequins are dried too quickly the iridescent effect can be diminished. FIG. 6 is a plot of drying time 603 and colour intensity 601 against temperature for a 300 μL solution at 10-15% relative humidity, and shows that the iridescence, or perceived colour intensity 601, is improved if the sequins are dried at a slow enough rate (which in this example is approximately 20-23° C. for approximately six hours).

### General Case

Whilst formation of a particular shape (sequins) using a particular type of flexible mould have been described hereinbefore, the present methods and the resulting membranes, are not limited thereto. Similarly, whilst the methods described hereinbefore have been described in relation to an aqueous solution of cellulose nanocrystals, the present methods and the resulting membranes are not limited thereto. In particular, the physics self-assembly of a suspension bound to within an area are not specific to an aqueous solution of cellulose nanocrystals drying within a flexible mould formed of silicone rubber. The same principles may be applied to self-assembly of a microstructure formed of any anisotropic nanocrystals (whether formed of organic materials, inorganic materials, or a blend of the two) by drying of a suspension of those anisotropic nanocrystals in a solvent. Confinement of the suspension to the outline of a desired shape (which is not limited to a sequin) may also be obtained in a variety of ways including moulds and/or templates.

Furthermore, the relative surface energies of interfaces between the suspension, air, the mould or template, and the self-assembled microstructure may control the shape of the membrane formed by drying the suspension. Without wishing to be bound be theory, this is believed to arise because of the anchoring cause by these interfacial energies, controlling the domain orientation to the mould and how it orientate at the edge. The hydrophobic nature of the mould or template caused a high contact angle and prevention of the suspension deposition up the sides, this causes the prevention/reduction of the coffee ring effect (where capillary flow deposits material as a ring on the edge of droplet) and anchoring to the substrate. As the liquid crystal domains seed and grow and deposit at the interface between the mould and suspension, a continuous change in helical axis occurs.

The mould may be formed of any material having a surface energy with the anisotropic nanocrystals such that formation of the self-assembled microstructure is energetically preferred at the air-suspension-mould interface (edge/1-D interface), relative to the suspension-mould interface (surface/2-D interface). The mould may be formed of any material having a poor adhesion to the self-assembled microstructure of the anisotropic nanocrystals, for example greater than or equal to a 50° contact angle. Contact angle can be measured using a contact angle goniometer to perform optical tensiometry measurements. The mould made be made of a material and a coating to produce the hydrophobic effect.

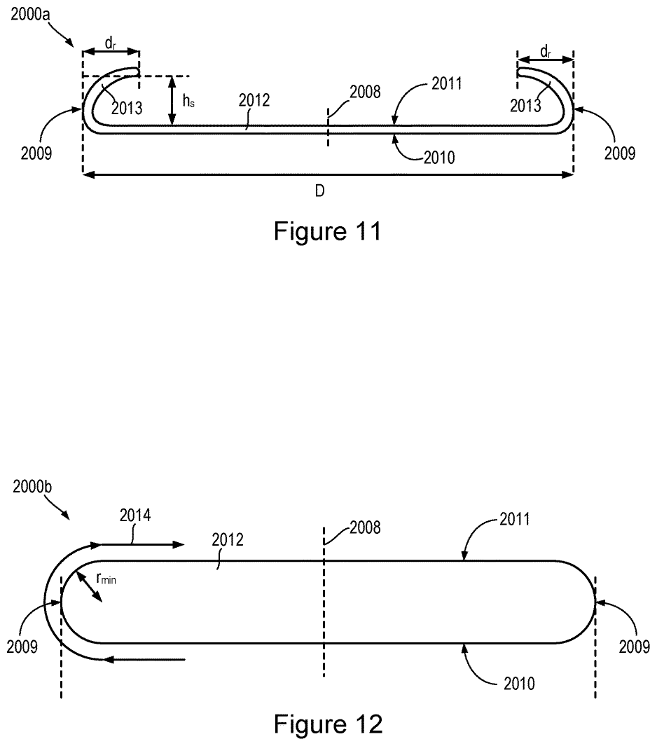

In particular, the shape or profile of the membrane around the perimeter may be controlled such that a sharp or thin edge may be avoided at the perimeter. Consequently, crack initiation/propagation may be suppressed at the perimeter (which in many loading scenarios may correspond to maximum stress). This edge effect creates a membrane that is less susceptible to breaking or cracking than previous membranes formed of a self-assembled microstructure of anisotropic nanocrystals. Examples of membrane shapes/edge effects which may be obtained are described from FIG. 11 to FIG. 14F described hereinafter.

Membranes formed in this way to have a self-assembled microstructure of anisotropic nanocrystals will also display similar interactions with light to the previously described iridescent sequins, provided that the typical spacing between the anisotropic nanocrystals is comparable to visible light. In other examples, the spacing may be controlled to cause structural colour and/or reflection in non-visible wavelengths of light such as infra-red or ultraviolet wavelengths.

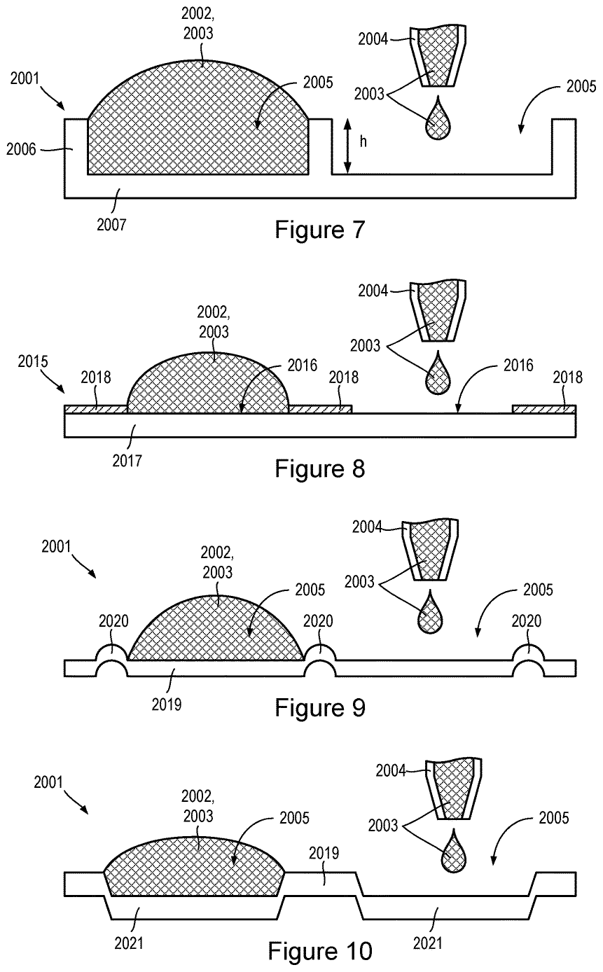

Referring also to FIGS. 7, 11 and 12, the general case of forming a membrane 2000a, 2000b in a mould 2001 is shown.

A volume 2002 of a suspension 2003 is dispensed into the mould 2001, for example use a pipette 2004 (which may be manual or automated). The suspension 2003 includes anisotropic nanocrystals suspended in a solvent. The anisotropic nanocrystals may be bacterial cellulose nanocrystals or neutralised cellulose nanocrystals. Examples of suitable anisotropic nanocrystals other than cellulose include, without being limited to chitin, non-organic, silicon, silica, polystyrene. Examples of solvents other than water include, without being limited to ethanol, glycerine, glycerol, IPA, methanol, acetone.

The mould 2001 generally takes the form of one or more wells 2005 (or receptacles), each defined by walls 2006 upstanding from a base 2007. The walls 2006 may typically be integrally formed with the base 2007. However, if a sufficiently good seal may be obtained (whether by pressure or otherwise), the walls 2006 may be separable from the base 2007 following drying of the membrane 2000a, 2000b, for example to facilitate removal. The height h of the wall 2006 is typically less than or equal to 3 mm. The height h may be much lower or higher depending on concentration of the suspension 2003, wall 2006 heights h for concentrations of cellulose nanocrystals above 2-8% wt can be lowered to 0.01-2.9 mm, with hole rod height 0.3-3.2 mm, with a membrane 2000a, 2000b (for example sequin) diameter D of 4-12 mm.

Each well 2005 (in particular floors/bases) may be non-flat, concave, convex or other shapes. The mould 2001 can be made from different materials, including without being limited to: silicon, PVC and other resins and polymers (including biopolymers and/or synthetic polymers). The mould 2001 could also be made from glass or metal with natural or treated surfaces. Other materials for the mould 2001 may include, for example: polystyrene, acrylic, PVC, urethane, wood, steel, aluminium, other alloys, paper, cardboard, textiles, mixed materials and different grades of silicones.

The volume 2002 is preferably larger than defined by the height h of the walls 2006, held from overflowing the walls 2006 by surface tension of the suspension 2003. The mould 2001 may be flexible, for example formed of silicone rubber as described hereinbefore. Alternatively, the mould 2001 may be rigid. In some examples, one of the base 2007 and walls 2006 may be flexible, whilst the other element is rigid.

Wells 2005 may be arranged to form an array, and each well 2005 may be considered a separate mould 2001 within the meaning of the present specification. Multiple wells 2005 may have identical shapes, but this is not essential, and a variety of well 2005 shapes (e.g. square, circular etc) may be provided on a single base 2007 is desired. When the wells 2005 are not identical, different volumes 2002 of suspension 2003 may be dispensed to each.

The dispensed volume 2002 of a suspension 2003 is then allowed to dry to form a membrane 2000a, 2000b having a self-assembled microstructure of the anisotropic nanocrystals. Two main cases are of interest which are illustrated respectively in FIGS. 11 and 12.

Referring in particular to FIG. 11, a schematic cross-section a first type of membrane 2000a (hereinafter the “first membrane”) is shown, which has a “recurved” edge effect.

The first type of membrane 2000a is formed of a self-assembled microstructure of anisotropic nanocrystals, and has a centroid 2008 and a perimeter 2009. A lower surface 2010 corresponds to a surface of the first membrane 2000a which formed in contact with the mould 2001, whilst an upper surface 2011 corresponds to the surface in contact with the air upon completion of the drying process. The first membrane 2000a is generally of a consistent thickness across a bulk region 2012 which includes the centroid 2008. However, around at least a majority of the perimeter 2009, the first membrane 2000a curves back on itself forming recurved portions 2013.

Recurved portions 2013 may have comparable thickness to the bulk region 2012, though in some cases may be thinner or thicker. Recurved portions 2013 extend back from the perimeter 2009 (i.e. back towards the centroid 2008) by a distance dᵣ generally parallel to the bulk region 2012 (on average, as the bulk region 2012 need not be flat). The recurved portion 2013 is separated from the upper surface 2010 of the bulk region 2012 that it curves back onto by a distance hₛ, which may be effectively zero (i.e. touching) in some cases.

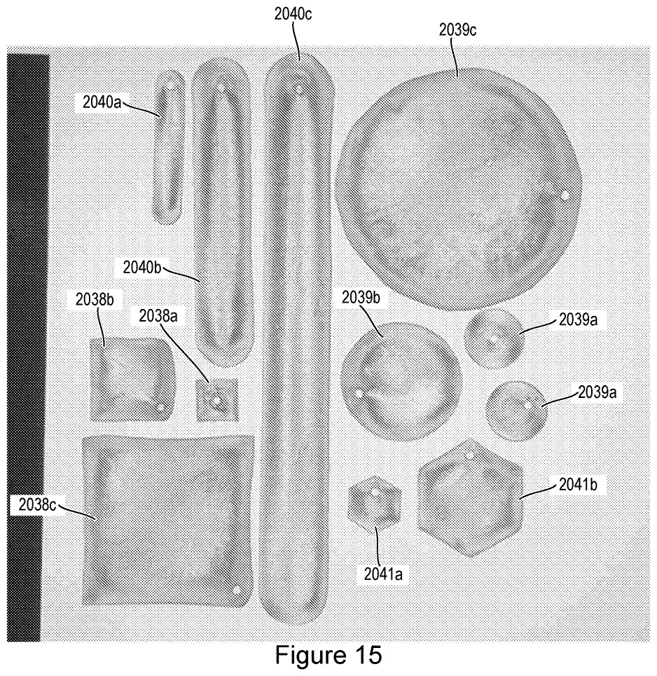

When the mould 2001 is circular, the perimeter 2009 will also be circular, with a diameter D corresponding generally to the well 2005 of the circular mould 2001. In this case, the parameters dᵣ, hₛ, general shape and thickness of the recurved portion 2013 will typically be consistent around the entire circular perimeter 2009. When the mould 2001 is not circular, and is instead square, rectangular and so forth (see also FIG. 15), the parameters dᵣ, hₛ, general shape and thickness of the recurved portion 2013 will typically vary with position around the perimeter 2009, for example a mid-point of a square perimeter 2009 will differ relative to a corner point of the same square perimeter 2009. However, in the correct conditions (described hereinafter), the recurved portion 2013 will be present around at least a majority of the perimeter 2009.

The first membrane 2000a is generally thin in one dimension, although it is not necessarily flat/planar (and in many applications is intentionally not flat), and does not enclose a volume. The first membrane 2000a, specifically the recurved portions thereof, may curve back on itself by a distance at least equal to a thickness of the membrane at the centroid 2008 (taking the centroid as representative of the bulk region 2012). When the first membrane 2000a is not flat, the perimeter 2009 may be determined by projecting the outline of the first membrane 2000a onto a plane perpendicular to the thickness of the membrane at the centroid 2008.

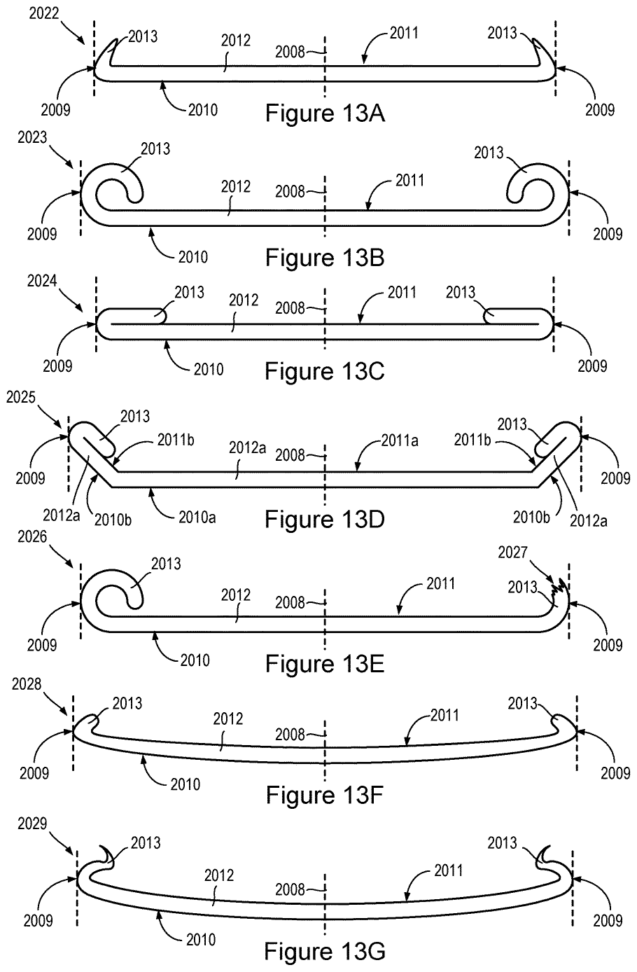

In this way, a sharp or thin edge may be avoided at the perimeter 2009. Consequently, crack initiation/propagation may be suppressed at the perimeter 2009 (which in many loading scenarios may correspond to maximum stress). This edge effect creates a first membrane 200a that is less susceptible to breaking or cracking than previous membranes formed of a cellulose nanocrystals (or similar). The re-curved portion 2013 may still terminate with a sharp/thin edge (see also FIGS. 13A and 13E) without losing the desired edge effect at the perimeter 2009.

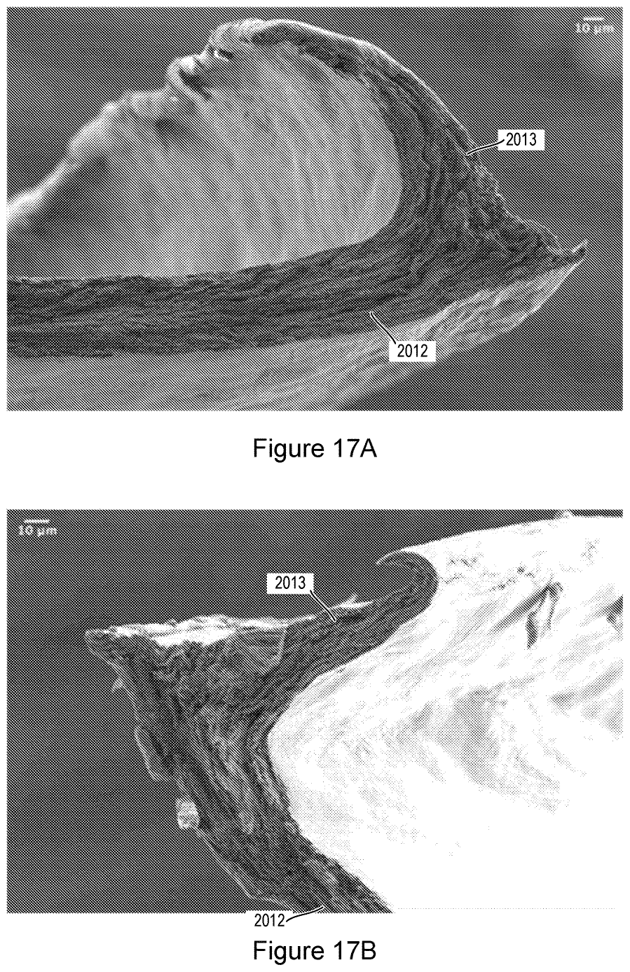

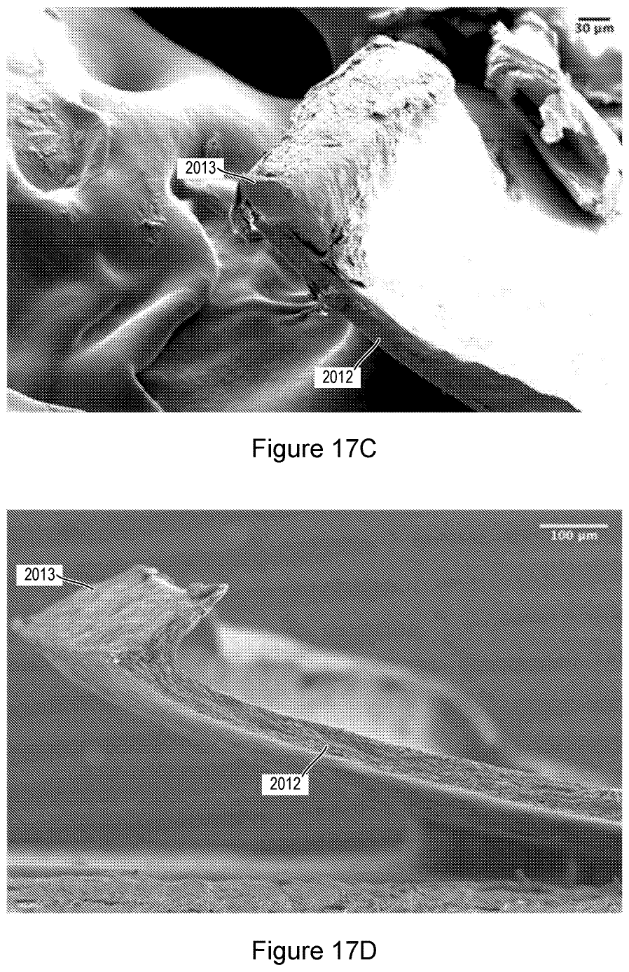

Without wishing to be bound be theory, formation of the first membrane 2000a having recurved portion(s) 2013 is believed to be promoted by the structural alignment continuation dominating over the structural anchoring to the mould 2001 or template 2015. Consequently, the alignment and continuous direction of the membrane 2000a is produced, causing a recurved shape, as can be seen experimentally in FIGS. 17A, 17B and 17D. This shapes of membranes 2000a differ from shapes of films formed in plastic or glass petri dishes in the prior art. In such prior art films, the anchoring to the petri dish dominates, producing an edge effect where the helical axis changes sharply. This typically results in a weak point in the structure at the edge where the film re-orients through a right angle onto the petri dish wall. This is often seen in literature where the material is formed up the side of the petri dish; see for example Largerwall et al,” Cellulose nanocrystal-based materials: from liquid crystal self-assembly and glass formation to multifunctional thin films” NPG Asia Mater. 2014, and Parker et al, “The Self-Assembly of Cellulose Nanocrystals: Hierarchical Design of Visual Appearance”, Adv. Mat. 2017. When such films are released (or attempted to be released) from the petri dish, the edge often fractures away from the main film. The edge regions does not always come away, but there is inherently a structure weakness present due to this defect.

Referring in particular to FIG. 12, a schematic cross-section a second type of membrane 2000b (hereinafter the “second membrane”) is shown, which has a “blunt” edge effect.

The second membrane 2000b is substantially the same as the first membrane 2000a, except that it does not include edge effects in the form of recurved portion(s) 2013.

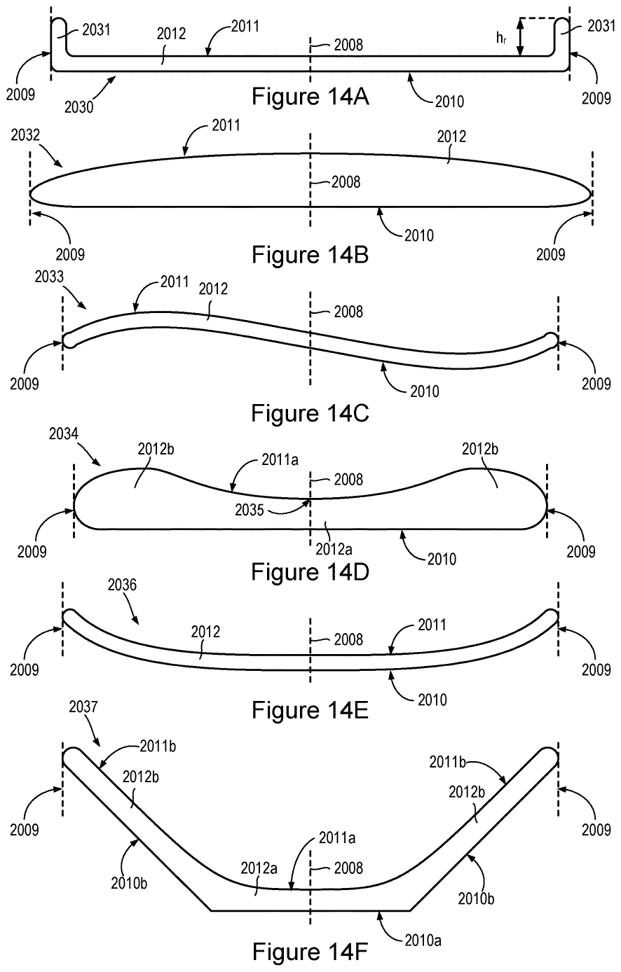

Instead, the cross-sectional profile of the second membrane 2000b is controlled such that moving from the upper surface 2011 to the lower surface 2010 (or the reverse direction) around any point on the perimeter 2009, a minimum radius of curvature rₘᵢₙ is at least 0.1 times the thickness of the second membrane 2000b at the centroid 2008 (taken as representative of the bulk region 2012 away from any edge effects). For example, following the path 2014 illustrated in FIG. 12. Whilst FIG. 12 illustrates the simple (special) case where the minimum radius of curvature rₘᵢₙ IS roughly equal to half the thickness of the second membrane 2000b at the centroid 2008, more complex cases are illustrated in FIGS. 14A though 14F. in practice, the minimum radius of curvature rₘᵢₙ is typically significantly less than half the thickness of the second membrane 2000b at the centroid 2008, though it should be controlled to be at least 0.1 times this thickness.

In the same way as for the first membrane 2000a, the second membrane 2000b avoids formation of a sharp or thin edge at the perimeter 2009 (in contrast to prior art examples of films formed using cellulose nanocrystals). Consequently, crack initiation/propagation may be suppressed at the perimeter 2009 so that the second membrane 2000b is less susceptible to breaking or cracking than prior art cellulose nanocrystal films (or similar).

Without wishing to be bound be theory, formation of the second membrane 2000n having controlled minimum curvature rₘᵢₙ is believed to be promoted by boundaries in the lateral dimensions via pinning or, by a physical boundary, in either case restricting the thinning/spreading of the material. This may be provided due to the repulsion of the mould 2001 materials and/or by the template 2015 producing a high contact angle. The second membrane 2000b may be formed at high concentrations (for example 3 to 10 wt %) of anisotropic nanocrystals in the suspension 2003, as too low a concentration (for example below 3 wt %) would produce too thin a bulk region 2012 of the resulting membrane 2000b. This may cause a change of angle of the cholesteric axis of the anisotropic nanocrystals at or close to the perimeter 2009.

An alternative approach to forming the second membrane 2000b is to first form the first membrane 2000a as illustrated in FIG. 11, and then depositing further material to fill in the area inside the recurved portions 2013 (for example one or more cycles of dispensing and drying the suspension 2003), so as to produce the shape of the second membrane 2000b. This second membrane 2000b provides a structure without a sharp point, weak point and/or brittle edge around the perimeter 2009.

Hereinbefore, the confinement of the suspension 2003 during drying to form membranes 2000a, 2000b of a desired shape has been described using moulds 2001 including one or more wells 2005 or receptacles 103. However, walls 2006 are not necessarily required and confinement may be provided in other ways, for example using control of surface tension/contact angles.

Referring also FIG. 8, a template 2015 for forming membranes 2000a, 2000b is illustrated in schematic cross-section.

The method described in relation to FIGS. 7, 11 and 12 may be carried out as described hereinbefore, escape that the template 2015 is used instead of mould 2001. The template 2015 includes one or more first, or “wettable”, regions of a template substrate 2017 which the suspension 2003 will wet, each wettable region 2016 surrounded and defined by one or more intervening second, or “un-wettable” regions 2018 which the suspension 2003 will not wet. The required volume 2002 of suspension 2003 is dispensed onto each wettable region 2016, and held in place by surface energy effects.

The suspension 2003 may be considered to wet a region 2016 if the contact angle of a drop of the suspension 2003 on that region 2016 is less than or equal to 90°. The suspension may be considered to not wet a region 2018 if the contact angle of a drop of the suspension 2003 on that region 2018 is greater than 90°. For example, when the suspension 2003 is aqueous, the wettable regions 2016 may be hydrophilic, whilst the un-wettable regions 2018 are hydrophobic.

A sufficient degree of pinning of the suspension 2003 to serve as a template 2015 may be provided by a contact angle of 60-75° or higher, for example an aqueous suspension 2003 on silicone rubber.

In the example shown in FIG. 8, the template substrate 2017 is wettable, and un-wettable regions 2018 have been defined by application of a thin coating. Of course, depending on the substrate, alternative surface modifications having no appreciable thickness may be used to modify wettability, for example chemical activation etc.

The template substrate 2017 may take any suitable form including, but not limited to, a film, a sheet, a plate and so forth. In some examples, the template substrate 2017 may take the form of a surface of a three-dimensional object. In other examples, the template substrate 2017 may take the form of a second membrane 2000a, 2000b of the same material. In general the template substrate 2017 may be a porous or non-porous. The porosity may be closed cell or open cell (infiltration of open cell porosity may be avoided by control of surface energies with respect to the suspension 2003 and/or by control of the size of anisotropic nanocrystals relative to pores.

The template substrate 2017 may include, or be formed from, a polymer such as, for example, polystyrene, acrylic, poly-vinyl chloride, urethane, polyurethane and so forth. The template substrate 2017 may include, or be formed from, a metal such as, for example, a steel, aluminium or other alloys (with natural or treated/coated surfaces), provided that there is no adverse reaction with the suspension 2003 solvent. The template substrate 2017 may include, or be formed from paper, card, wood, glass, a fabric, a textile (synthetic or natural), a fibrous mat, silicone rubber (of various grades), natural rubber, or a laminate or two or more such materials.

Referring also to FIG. 9, in one specific example of implementing a mould 2001, one or more wells 2005 may be formed by embossing a mould substrate 2019 to form embossed mould walls 2020. The mould substrate 2019 may be of any type or material described in relation to the template substrate 2017.

Referring also to FIG. 10, in another specific of implementing a mould 2001, one or more wells 2005 may be formed by debossing a mould substrate 2019 to form debossed regions 2021. Again, the mould substrate 2019 may be of any type or material described in relation to the template substrate 2017.

Such embossed/debossed mould substrates 2019 may be formed to make moulds 2001 which are intended to be temporary or semi-temporary, allowing the deposition of a membrane 2000a, 2000b in a designed shape directly onto the conditioned mould substrate 2019. In other examples, it may be intended to leave the membrane 2000a, 2000b adhered to the embossed/debossed mould substrate 2019.

### Examples of the First Membrane

The first membrane 2000a structure may be better understood with reference to a (non-exhaustive) number of examples.

Referring also to FIG. 13A, a schematic cross-section of a first example 2022 of the first membrane 2000a is shown.

The first example 2022 has recurved portions 2013 which taper to a thickness which is less (and in some implementations could be much less) than the thickness of the bulk region 2012 (for example as taken at the centroid 2008). Despite this, the first example 2022 retains resilience against cracking due to the thickness and broad radius of curvature at the perimeter 2009, provided by the edge effect of the recurved portions 2013.

In common with other examples (see FIGS. 13B to 13G) of the first membrane 2000a, the recurved portions 2013 may also prevent catching and/or damage to other materials by the perimeter 2009 of the membrane 200a, for example when used in textiles. For application as a glitter, this shape prevents a sharp edge which may be dangerous for the use of a glitter in cosmetics or other products for application to skin (for example due to micro-abrasion and/or the possibility of being displaced to eyes or other sensitive membranes of a user). Damage to surfaces of objects to which a first membrane 2000a such as the first example 2022 is applied/coated may also be avoided.

Referring also to FIG. 13B, a schematic cross-section of a second example 2023 of the first membrane 2000a is shown.

The second example 2023 has recurved portions 2013 which continue to curve back onto themselves such that the edges are directed back down towards the upper surface 2011 of the bulk region 2012. This may improve rigidity by forming a tube-like structure around at least part of a perimeter 2009. Additionally, the potentially thinner edge may be protected by being curved around towards the structure.

The second example 2023 has been illustrated with recurved portions 2013 having a thickness substantially the same as the bulk region 2012, however this is not essential. The recurved portions 2013 of the second example 2023 could instead having a thickness which is reduced and/or tapers, as described in relation to the first example 2022. The second example 2023 having a tapered thickness may still fragment, but should this occur the tapering and potentially sharp edge will be curled in towards the bulk portion 2012 of a corresponding fragment, where there is a reduced likelihood of damage to external materials.

Referring also to FIG. 13C, a schematic cross-section of a third example 2024 of the first membrane 2000a is shown.

The third example 2024 has recurved portions 2013 which extend back towards the centroid 2008 with a height separation hₛ that is small relative to the membrane 2000a thickness (or even negligible/touching contact). In other words, recurved portions 2013 lie substantially flat against the upper surface 2011 of the bulk region 2012. This type of compact profile may help to provide the improved toughness against cracking initiated at/spreading from the perimeter 2009, whilst minimising the increase (from second moment of area) to rigidity of the membrane 2000a.

The shape of the third example 2024 may provide further improvement of mechanical strength at the perimeter 2009, and additionally may create less of a change of helical axis of the anisotropic nanocrystals, which also directly affects the observed structural colour. In this way, a change in angle of colour reflected with viewing angle may be reduced. The third example 2024 has a flatter shape with less of a significant edge profile, compared to the first example 2022. The third example 2024 may be favoured when the membrane 2000a has a high flexibility, which can be induced in practice by varying the formulation (% wt of anisotropic nanocrystals), the thinness of membrane 2000a (for example 0.5 to 40 μm), the humidity (for example 60% or more) and the speed of drying (for example 24 hours or longer).

The third example 2024 has been illustrated with recurved portions 2013 having a thickness substantially the same as the bulk region 2012, however this is not essential. The recurved portions 2013 of the third example 2024 could instead having a thickness which is reduced and/or tapers, as described in relation to the first example 2022.

Referring also to FIG. 13D, a schematic cross-section of a fourth example 2025 of the first membrane 2000a is shown.

The fourth example 2025 is the same as the third example 2024, except that the first membrane 2000a was formed in a mould 2001 which had a shaped base 2007 defining all or part of a 3D shape. In the example shown, a first part of the bulk region 2012a forms a first, flat face (or facet), which transitions to second parts of the bulk region 2012b forming second, angles face(s) or facet(s). For example, the lower surfaces 2010a, 2010b may have the appearance of a portion of a surface such as a dodecahedron, a coidoid, a pyramid, a sphere, a tetrahedron, a torus, or any other curved or polyhedral (regular or irregular) shape.

The fourth example 2025 has been illustrated relative to the third example 2024. However, similar 3D mould shapes may be used with either one of the first 2022 and/or second 2023 examples.

In order to achieve 3D shapes, the viscosity of the suspension 2003 should be high, and the material choices should promote some pinning and/or adhesion of the suspension 2003 and/or anisotropic nanocrystals to the mould 2001 or template 2015, so the self-assembled microstructure of the anisotropic nanocrystals is not deposited at the bottom of the mould.

Referring also to FIG. 13E, a schematic cross-section of a fifth example 2026 of the first membrane 2000a is shown.

The fifth example 2026 is the same as the second example 2023, except to illustrate a situation in which at least a section of a recurved portion 2013 has been damaged, for example by fracturing due to a pressure applied down (relative to the illustrated cross-section), leaving that recurved portion 2013 terminating in a fracture surface 2027. Provided that the damage does not extend up to/past the perimeter 2009, the edge effects at the perimeter 2009 may be retained.

The fifth example 2026 has been illustrated relative to the second example 2023. However, are applicable to any of the first 2022, third 2024 and/or fourth 2025 examples.

Referring also to FIG. 13F, a schematic cross-section of a sixth example 2028 of the first membrane 2000a is shown.

Unlike the first 2022 to fifth 2026 examples, the bulk portion 2012 of the sixth example 2028 is not flat or faceted, and instead has a curvature. The curvature may arise from contraction/residual strains upon drying, or may be intentionally introduced by the shape of a mould 2001. This curvature means that a structural colour reflection will be observable across a wider range of observing angles. When used to form glitter, this curvature may also enhance the membranes 2000a sticking to the skin (or other surfaces) via a suction mechanism due to a concave shape.

Any of the first 2022 to fifth 2026 examples may include a bulk portion 2012 having an intentional or unintentional curvature.

Referring also to FIG. 13G, a schematic cross-section of a seventh example 2029 of the first membrane 2000a is shown.

The first 2022 to sixth 2028 examples illustrate recurved portion(s) 2013 which curve in a single sense of rotation-back towards the centroid 2008. In contrast to this, the recurved portion(s) 2013 of the seventh example 2029 have a “double recurved” shape, which first curves back towards the centroid 2008 before changing the sense of rotation to curve back towards the perimeter 2009.

Any of the first 2022 to sixth 2028 examples may instead include recurved portion(s) 2013 having a “double recurved” shape similar to the seventh example 2029.

The seventh example 2029 may be favoured when the first membrane 2000a has a high flexibility which can be induced by the formulation, thinness of membrane, humidity (for example 60% or more) and speed of drying (for example 24 hours or more). The double recurved shape is favoured by particularly slow drying, which causes the suspension anchor to the wall of the mould at the first 50% of the drying process then the wall collapses, but curls in slowly leading to a ‘tail’ to curve in the opposite direction.

### Examples of the Second Membrane

The second membrane 2000b structure may be better understood with reference to a (non-exhaustive) number of examples.

Referring also to FIG. 14A, a schematic cross-section of a first example 2030 of the second membrane 2000b is shown.

The first example 2030 does not include recurved portions 2013, but around the perimeter the first example 2030 does include upwardly extending (relative to the lower surface 2010) rim portions 2031 around at least a part of the perimeter 2009. Although shown with the same thickness as the bulk region 2012, the rim portions 2031 may have a reduced and/or tapering thickness. The rim portions 2031 extend to a height hr above the bulk region 2012, and this height hr should not exceed about 3 mm. More generally, the height hr is preferably less than or equal to 50 times the thickness of the bulk region 12 (for example represented by the thickness at the centroid 2008).

The rim portion 2031 may form corresponding a height of walls 2006 which are above the bulk region 2012 thickness of the membrane 2000b. Without wishing to be bound by theory, the formation of a rim portion 2031 is believed to result from pinning of the self-assembling microstructure of anisotropic nanocrystals to the edge of the mould 2021, thickness of the bulk portion 2012 and/or the speed of drying, this occurs when concentration is 3-8 wt % or an high viscosity additive is used for example hydroxyl propyl cellulose.

Referring also to FIG. 14B, a schematic cross-section of a second example 2032 of the second membrane 2000b is shown.

The second membrane 2000b illustrated in FIG. 12 has a minimum radius of curvature rₘᵢₙ which is equal to about half the bulk region 2012 thickness (represented for example by a thickness at the centroid 2008). However, this is not essential, and as illustrated by the second example 2032, the minimum radius of curvature rₘᵢₙ may be less than half the bulk region 2012 thickness, provided that it is at least 0.1 times this thickness.

The second example 2032 may also include a rim portion 2031 as described in relation to the first example 2030.

The second example 2032 may be useful for applications to form (in whole or part) objects such as glitter, tinsel, rhinestones, confetti and other free standing membrane applications, enabling a smooth edge. The edge profile of the second example 2032 may provide an embossed feel to a coating (as perceived against a persons' skin), to give a coating an appealing luxury effect.

Referring also to FIG. 14C, a schematic cross-section of a third example 2033 of the second membrane 2000b is shown.

The bulk region 2012 of the third example 2033 is curved, in the example shown the schematic cross-section illustrates an s-shaped curvature, which may be prismatic out of plane or may be part of a more complex shape, for example saddle-shaped. This curvature may arise from drying/residual strains (though this may be intentionally caused), or from a mould 2001 shape. Membranes 2000b having curvature may be used for particular visual effects, since at least part of the surfaces 2010, 2011 will meet a diffraction/reflection condition from the self-assembled microstructure of anisotropic nanocrystals across a broader range of viewing/illumination angles. Either of the first 2030 and/or second 2032 examples could be modified to have a curved bulk region 2012.

A greater curvature of the bulk region 2012 may be produced using, for example a suspension of a high concentration 4-8 wt % cellulose nanocrystals in aqueous suspension 2003. Additionally or alternatively, curvature may be enhanced/promoted by including a high viscosity additive in the suspension 2003, such as sorbitol, hydroxyl propyl cellulose. Additionally or alternatively, curvature may be enhanced/promoted by drying under oil, or in high humidity (for example 60% or more).

Referring also to FIG. 14D, a schematic cross-section of a fourth example 2034 of the second membrane 2000b is shown.

The fourth example 2034 has a first part of the bulk region 2012a which is relatively thinner than one or more relatively thicker second parts of the bulk region 2012b formed around at least part of the perimeter 2009. A minimum thickness 2035 of the first part of the bulk region 2012a may coincide with the centroid 2008, but does not need to. This demonstrates that the minimum radius of curvature rₘᵢₙ may in some examples be larger than the thickness at a centroid 2008 of the membrane 2000b.

Any of the first 2030, second 2032 and/or third 2033 examples could be modified to have relatively thicker second parts of the bulk region 2012b formed around at least part of the perimeter 2009.

The fourth example 2034 may enable the use of less material, and may have reduced total membrane 2000b weight, whilst still creating the same thick edge effect at the perimeter 2009. The fourth example 2034 may be favoured by increasing the coffee ring effect (whereby capillary flow induces particles to be deposited at the edge of a droplet), by lowering viscosity of the suspension 2003 by avoiding high viscosity additive concentrations or by lowering the wt % concentration of anisotropic nanocrystals, for example in the range of 0.5-4% for cellulose nanocrystals in an aqueous suspension 2003. This allows capillary flow. Additionally or alternatively, the fourth example 2034 may be favoured by one or more of decreasing drying time (for example less than 24 hours with 2 wt % suspension), reducing humidity (for example between 30-50%), increasing air flow, or increasing temperature during drying (for example 25-45° C.).

Referring also to FIG. 14E, a schematic cross-section of a fifth example 2036 of the second membrane 2000b is shown.

The fifth example 2036 is the same as the third example 2033, except that the bulk region 2012 only curves in a single sense.

Any of the first 2030, third 2033 and/or fourth 2034 examples could be modified to have curvature similar to the fifth example 2036.

The concave effect exhibited by the fifth example 2036 has a consequence of increasing the breath of possible angles of observation of structural colour. Glitter formed in accordance with the fifth example 2036 may have improved adhesion/retention on skin (or other surfaces) due to a suction cup effect from the concave shape. The fifth example may be promoted by slowing down drying times, and/or using additives with larger lateral sizes such as, for example, graphene having 200-300 nm diameter.

Referring also to FIG. 14F, a schematic cross-section of a sixth example 2037 of the second membrane 2000b is shown.

A lower repulsion between the substrate and suspension is required with 3D shapes (relative to flat shapes), to allow pinning on the mould 2001, instead of pooling of suspension 2003 at the bottom of the mould 2001. The vertices of these shapes have the same continuation of structure at the bend as with the edge effect.

In the same way as the fourth example 2025 of the first membrane 2000a, the sixth example 2037 of the second membrane 2000b was formed in a mould 2001 which had a shaped base 2007 defining all or part of a 3D shape.

Any of the first 2030 to fifth 2036 examples could be modified to have sharp transitions between surfaces/facets, using a mould 2001 which had a shaped base 2007 defining all or part of a 3D shape.

### Membranes Dried as a Single Piece

In order to obtain the beneficial edge effects described herein, each membrane 2000a, 2000b (and any examples thereof) should be formed by drying as a single piece. Cutting shapes from a single, large bulk region 2012 would not produce the relevant edge effects, and may also introduce sharp edges/cracks which will be detrimental to toughness (against fracturing).

The origination of a membrane 2000a, 2000b as having been formed as a single piece by drying of the suspension comprising the anisotropic nanocrystals may be determined from examination of the directional alignments of the anisotropic nanocrystals. These will also demonstrate edge effects, due to the self-assembly typically propagating inwards from the boundary between air, mould 2001/template 2015 and suspension 2003, as opposed to occurring simultaneously throughout the suspension 2003. This is analogous to microstructural edge effects which will be evident in other systems such as injection moulded polymers, cast alloys and so forth.

Such microstructural edge effects (as opposed to the shape edge effects described hereinbefore) will typically (but not exclusively) be exhibited in the average directional alignments of the anisotropic nanocrystals, and may be determined in a number of ways, including but not limited to:
Microscopy of fracture surfaces (e.g. intentionally generated by snapping);
Microscopy of cross-sections (for example polished);
X-ray crystallography to determine the orientation (sometimes termed “texture”) of the anisotropic nanocrystals; or
When the membrane is at least partly transparent, by examination of the membrane 2000a, 2000b using visible light between crossed polarizers.

The latter approach, namely examination using visible light between crossed polarizers, is particularly preferred due to the relative ease and simplicity of the method.

In the case that edge-effects in the directional alignments of the anisotropic nanocrystals are substantially similar heading from any point on the perimeter towards the centroid, the membrane has been formed as a single piece by drying of the suspension comprising the anisotropic nanocrystals. When this is not the case, this indicates that a membrane has been cut from a larger object (in doing so, removing some edge-effected regions).

Referring also to FIG. 15, examples of membranes 2000a with recurved edge portions 2013 and having a variety of shapes were produced and imaged between differently configured polarisers.

The membranes 2000a of different shapes were produced in respective silicone rubber moulds 2001 having wall 2006 heights h varying between 0.1-0.7 cm. In all cases, the suspension 2003 used was 2% wt of cellulose nanocrystals in water, with a 10% dry mass of sorbitol. The drying time was 12 hours.

As described herein, the membranes 2000a or different shapes all exhibit an edge effect where the structure varies with distance from the perimeter 2009, demonstrating that the edge effect can produce membranes of different shapes and sizes, not limited to circles. The examples pictured are small (0.7 cm) 2038a, medium (1.25 cm) 2038b and large (2.5 cm) 2038c square membranes, small (1 cm) 2039a, medium (2 cm) 2039b and large (5 cm) 2039c circular membranes, small (2.5 cm long) 2040a, medium (5 cm long) 2040b and large (9 cm long) 2040c oval membranes, and small (1 cm diameter) 2041a, and large (2 cm diameter) 2041b hexagonal membranes.

Through-holes (not labelled in FIG. 15) are provided either proximate to the perimeter 2009 or at the approximate centroid 2008.

In all cases, the edge effects are continuously (if not uniformly) observed around the perimeter 2009 of each membrane 2000a.

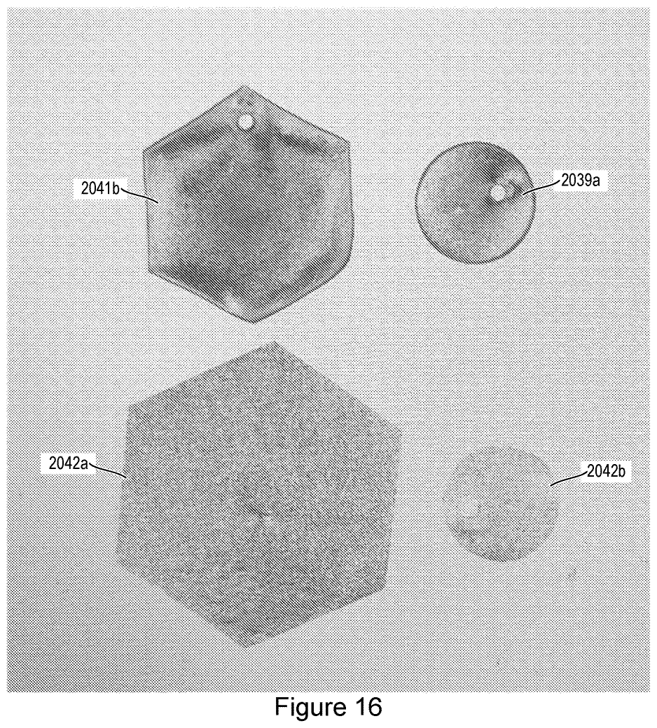

Referring also to FIG. 16, a shapes 2042a, 2042b physically cut from a sheet having the same formulation as the membranes 2000a shown in FIG. 15 are pictured. A small circular membrane 2039a and large hexagonal membrane 2041b are also pictured for comparative purposes. FIG. 16 was obtained in the same conditions and FIG. 15.

The difference in the material variation across the shapes is clearly observed. For the hexagonal 2042a and circular 2042b shapes, there is no difference in the interaction of light at the edge vs the centre of the shape. In contrast to this, the edge effect of the membranes 2000a is clearly apparent.

In this way, it is straightforward to distinguish a membrane 2000a, 2000b formed by drying as a single piece as described herein from a shape of similar shape and thickness formed by cutting from a bulk film having identical material composition.

### Perimeter Shapes of Membranes

Although it should be apparent from the preceding discussion that membranes are not limited to circular/sequin shapes, for the avoidance of doubt membranes 2000a, 2000b may have a shape which is a circle, an oval, a triangle, a square, a rectangle, or any other regular or irregular shape. If desired, a membrane 2000a, 2000b may be formed to have a shape corresponding to a letter, number, symbol, logo and so forth.

The membranes 2000a, 2000b may be generally planar or film-like, or may have a shape of a film conformed to the surface of a three-dimensional shape. For example, membranes 2000a, 2000b formed by drying of a suspension of the anisotropic nanocrystals within a mould having the corresponding shape (see FIGS. 13D and 14F for example)

These three dimensional shapes can also then be subsequently filled to create solid shapes with an iridescent surface colour. Suitable filling materials include, without being limited to, polymers such as cellulose acetate.

### Microstructure and Volume Fraction of Anisotropic Nanocrystals

The anisotropic nanocrystals preferably comprise a volume fraction of at least 80% of the self-assembled microstructure of the membrane 2000a, 2000b. More preferably, the anisotropic nanocrystals may have a volume fraction of at least 90% of the self-assembled microstructure. Preferably, the anisotropic nanocrystals may be homogenously distributed throughout the volume of the membrane 2000a, 2000b.

Some examples are set-out in Table 2, along with examples of secondary materials included in the microstructure (i.e. belonging to the fraction other than the anisotropic nanocrystals):

TABLE 2
The “Secondary materials” do not necessarily (but may) form the balance
of the microstructure, since the membranes 2000a, 2000b may also include further
additives to the specifically named examples (as described hereinafter).

| Wt % of anisotropic | | |
|---|---|---|
| nanocrystals | Material of other fraction | Effects |
| 70-99% | Sorbitol | Increase mechanical strength, |
| | | reduction of colour intensity |
| 75-99% | Cellulose nanofibers | Increase mechanical strength, |
| | | gives a cloudy effect |
| 90-99% | Natural rubber | Increase mechanical strength, |
| | | gives a white colour |
| 90-99% | Hydroxyl propylcellulose | Increase mechanical strength |
| 95-99% | Microcrystalline cellulose | Increase mechanical strength |
| | | gives a cloudy effect |
| 10-99% | Poly(3-hydroxybutyrate-co- | Increases mechanical strength |
| | 3-hydroxyvalerate) | decreases colour intensity |
| | | colour |
| 10-99% | Polycaprolactone | Increases mechanical strength |
| | | decreases colour intensity |
| | | colour |
| 10-99% | Polybutylene succinate | Increases mechanical strength |
| | | decreases colour intensity |
| | | colour |
| 10-99% | Vinyltriethoxysilane | Increases mechanical strength |
| | | decreases colour intensity |
| | | colour |

The self-assembled microstructure of anisotropic nanocrystals will typically exhibit structural colour, due to alignment and typical spacing of the anisotropic nanocrystals. In some implementations, the self-assembled microstructure of anisotropic nanocrystals may be controlled to exhibit reflection at a desired target wavelength. Either effect may be controlled to occur within visible, infrared or UV wavelengths by controlling the typical spacing of the anisotropic nanocrystals.

The colour produced is dependent on the cholesteric pitch, orientation of the helical axis, the degree of order in the cholesteric and the wavelength polarization and propagation direction of the incident light

The anisotropic nanocrystals are capable of self-assembling into chiral nematic liquid crystals or cholesterics before they transition into the solid state (this process can occur by solvent evaporation causing concentration increase) to produce membranes 2000a, 2000b with ordered, self-assembled microstructures that can refract light to produce structural colour. This self-assembly can be tuned, it is driven by a balance between attractive van der Waals forces and repulsive interactions, these interactions can be controlled by tunning in a number of ways, e.g. the charge of the particles, ionic strength and so forth.

In some examples, the self-assembled microstructure of anisotropic organic nanocrystals may be caused to exhibit disorder in the relative alignment of the anisotropic organic nanocrystals—for example by tuning the self-assembly to result in tilted domains, non-clearly defined domains, small domains, big variations in pitch of structure, and so forth. This may be achieved by reducing the global alignment of the anisotropic nanocrystals across of the membrane 2000a, 2000b, which has to occur after the suspension reaches a critical concentration (usually ~4-8 wt %) during drying but before kinetic arrest (around 6-10 wt %). Where the crystal domains align, the self-assembled microstructure can have parallel cholesteric axis across the membrane 2000a, 2000b, but this global alignment may not be achieved, producing domains with differing cholesteric axis angles. Such structures may be observed via polarised optical microscopy and/or scanning electron microscopy (SEM). Such less ordered (or even disordered) microstructures may provide different optical effects, such as wider angle of observation, a pixelated glitter effect (describing small specks of different colours), range of colours produced, and so forth.

### Additives

The membranes 2000a, 2000b need not, and generally are not, formed purely from the self-assembled microstructure of the anisotropic nanocrystals. Various types of additives may be included in the suspension 2003 for incorporation into the microstructure, in order to modify the properties thereof-subject to the restrictions on volume/weight fraction as described hereinbefore. The additives described hereinafter, and further additives, may be included in any combination.

The self-assembled microstructure of anisotropic nanocrystals may include one or more pigments. These pigments may be added to the suspension 2003 as separate additives which are simply incorporated in/around the self-assembled microstructure. Alternatively, pigments may be included directly in the anisotropic nanocrystals.

A membrane 2000a, 2000b (or a suspension 2003 for formation thereof) may include a mixture or blend of two or more pigments. Pigments may be inorganic or organic.

A membrane 2000a, 2000b may have a colouring partly produced by structural colour from the self-assembled microstructure of anisotropic nanocrystals and partly by any which are included pigments

Alternatively, when the self-assembled microstructure of anisotropic nanocrystals does not exhibit structural colour, the coloration of such a membrane 2000a, 2000b may be dominated by any pigments included (in combination with an underlying colour of the anisotropic nanocrystals).

The suspension 2003 (and resulting membranes 2000a, 2000b) may also include additives in the form of plasticizers. For example, sorbitol Glycerol, propylene glycol, polyethylene glycols and organic esters. These additives may enhance the mechanical strength of the membranes 2000a, 2000b, without disrupting the self-assembly of the nanocrystals.

The suspension 2003 (and resulting membranes 2000a, 2000b) may also include additives in the form of cross-linking agents. For example, phytic acid.

The suspension 2003 (and resulting membranes 2000a, 2000b) may also include additives in the form of high contrast absorbers. For example, carbon black, graphite, graphene, graphene oxide and so forth.

The suspension 2003 (and resulting membranes 2000a, 2000b) may also include additives in the form of inorganic particles. For example, silicon.

The suspension 2003 (and resulting membranes 2000a, 2000b) may also include additives in the form of oils and/or waxes. When included, the oils and/or waxes may be distributed within the self-assembled microstructure of anisotropic nanocrystals. Additionally or alternatively, oils and/or waxes may form, or may be applied post-drying as, a coating of the membrane 2000a, 2000b. In some examples, oils and/or waxes may be encapsulated by another material or cell. Oils may be synthetic or natural, for example, vegetable oils, seed oils, silica based oil and so forth. Waxes may be synthetic or natural, for example, paraffin, rice bran wax, bees wax, carnuba wax and so forth.

The suspension 2003 (and resulting membranes 2000a, 2000b) may also include additives in the form of fibres. For example, the fibres may be cellulose fibres and the anisotropic nanocrystals may be cellulose nanocrystals. For example, hemicellulose, cellulose fibre, cellulose nanofiber, cellulose fibrils, and so forth.

The suspension 2003 (and resulting membranes 2000a, 2000b) may also include additives in the form of polymers such as, for example, lignin latex, polyvinyl alcohol, hemicellulose and so forth.

The polymer may function as a plasticizer or to provide cross-links between the anisotropic nanocrystals (i.e. the previously described plasticiser/cross linker may be in the form of a polymer). Alternatively, the polymer may take the form of a matrix within which the anisotropic nanocrystals are embedded. The polymer may have the same monomer unit(s) as the anisotropic nanocrystals.

### Through Holes

The membranes 2000a, 2000b (or examples thereof) may include one or more through-holes. A through-hole may be circular, square, rectangular, or any other regular or irregular shape. The though-hole is preferably integrally formed at the time of forming the membrane 2000a, 2000b, not cut, drilled or punched after formation of the membrane 2000a, 2000b.

Through holes may be formed using rods or similar protrusions, in the same way described in relation to rods 107 in relation to the example of sequins formed from cellulose nanocrystals.

When a template 15 is used, rods or similar protrusions may be used to form through holes. Alternatively, through-holes, or at least thinned regions for creating through-holes, may be formed by addition of un-wettable regions 2018 wholly surrounded by wettable regions 2016.

### Materials for the Membranes

Examples have been described relating to formation of membranes 2000a, 2000b using cellulose nanocrystals in aqueous suspension 2003. However, as discussed herein, the same principles of physical and colloidal chemistry are applicable to suspensions of a broader range of anisotropic nanocrystals in a range of different solvents/solvent blends.

Preferably, the anisotropic nanocrystals are formed of a biopolymer such as, for example, chitin, cellulose nanocrystal such as bacterial cellulose nanocrystals or neutralised cellulose nanocrystals, or a mixture in which the cellulose nanocrystals or chitin induces self-assembly and other particles follow.

### Articles Including the Membranes

The membranes 2000a, 2000b described herein are often releasable from the mould 2001 or template 2015, and are then mechanically self-supporting. Such membranes 2000a, 2000b are not supported on a substrate. In other words, the membranes 2000a 2000b may be freestanding.

However, there are applications for which it may be desired to incorporate the membrane 2000a, 2000b into a larger article.

In a first example, an article (not shown) may include a membrane 2000a, 2000b supported on a substrate (not shown). The substrate may be a film, a sheet, a plate, or even the surface of a three-dimensional object. In some examples, the substrate may be a second membrane 2000a, 2000b of the same type and/or material. The substrate may be a porous material, for example closed cell or open cell. The substrate may include, or be formed from, a polymer, paper, card, a fabric, a fibrous mat, a laminate of one or more of the preceding types, and so forth.

Such an article may be formed by drying the membrane 2000a, 2000b directly onto the substrate (not shown), for example by applying un-wettable regions 2018 to define the perimeter 2009. Alternatively, walls 2006 formed of a resilient material such as silicone rubber may be attached to, or pressed against, the substrate for the duration of dispensing and drying the suspension 2003.

Alternatively, a free-standing membrane 2000a, 2000b may be adhered to the substrate using adhesive, or depending on the material of the membrane 2000a, 2000b, may be wetted with a solvent (for example the same one used in the suspension 2003). The wetted free-standing membrane 2000a, 2000b will then be placed or pressed into contact with the substrate, and allowed to dry. This can be achieved on different surface materials, for example, glass, wood, metal, textiles and so forth. These surfaces can be non-flat surfaces. The wetting of the membrane 2000a, 2000b allows the structure to swell, allowing a small amount of movement of the anisotropic nanocrystals within the self-assembled microstructure structure, allowing them to orientate to the interface of the substrate to create adhesion.

In a second example, an article (not shown) may include a membrane 2000a, 2000b bonded between a first layer (not shown) and a second layer. In other words, the second example of an article forms a laminate. The first and second layers may take any form described hereinbefore in relation to the substrate (not shown) of the first example of an article (not shown). The first and second layers may be formed of different materials.

In a third example, an article (not shown) may include a coating (not shown) covering at least one surface of a membrane 2000a, 2000b. The coating may provide a barrier layer protecting the self-assembled microstructure of anisotropic nanocrystals from moisture, chemicals to which it may be exposed (for example cleaning products/compositions), and so forth. The coating may modify or augment mechanical properties of the membrane 2000a, 2000b, for example by increasing rigidity, by filling in cracks and so forth. The surface of the membrane 2000a, 2000b not covered by the coating may be bonded to, or supported on, a substrate (not shown) as described hereinbefore in relation to the first example of an article (not shown).

Optionally, the coating may encapsulates a majority of the surface of the membrane 2000a, 2000b, for example at least 90% of the surface, or even the whole surface of the membrane 2000a, 2000b.

Coating the membrane 2000a, 2000b may enable a greater range of properties and/or appearances to be achieved for an article. For example a cellulose acetate coating could allow creating a water resistant sequin primarily formed of cellulose nanocrystals formed into a membrane 2000a, 2000b. In this way, a layered article may be formed, with a structurally coloured core (the membrane 2000a, 2000b), surrounded by a protective coating, providing a combination of water resistance, structural colour and mechanical strength.

In a fourth example, an article (not shown) may include a membrane 2000a, 2000b embedded in a transparent material (not shown). For example, the membrane may be embedded in a transparent epoxy (not shown) cast into a mould (not shown) in which the membrane 2000a, 2000b (or several membranes) is (are) pre-positioned, to form the shape of a jewel. This method may be used to produce beads/costume jewels benefiting from the optical characteristics of the membranes 2000a, 2000b.

Membranes 2000a, 2000b described herein, or articles (not shown) including those membranes 2000a, 2000b, may be used to provide, without being limited to, sequins, sequin reels, sequin trim, sequin mesh, glitter, jewels, gems, jewellery, costume jewellery, pendants, pieces to colour, ear pendants, buttons, stickers, spangles, rhinestones, hot fix crystals, embellishments, beads, nail art, glass stickers, decorative, confetti, tags, tokens, tinsel, or any other types of object used or applied to provide specular reflection, sparkle, iridescence or similar effects to an object.

Membranes 2000a, 2000b described herein, or articles (not shown) including those membranes 2000a, 2000b, may be used to provide, without being limited to, puzzle pieces, coasters, poker chips, trading cards, game pieces and so forth.

Membranes 2000a, 2000b described herein, or articles (not shown) including those membranes 2000a, 2000b, may be applied to fabrics or other surfaces by applying the suspension comprising the anisotropic nanocrystals using a screen printing process, a dot-matrix printing process, a spot printing process, an UV printing process, an inkjet printing process, a flexographic printing process, a gravure printing process, a lithographic printing process, and so forth.

Membranes 2000a, 2000b described herein, or articles (not shown) including those membranes 2000a, 2000b, may be used as a replacement for foiling of fabrics, paper, card and so forth.

The methods described herein may be used to produce membranes 2000a, 2000b having long elongated shapes such as, for example, sequin reels (sometimes also called “sequin ribbon”) on a roll, maintaining the edge effect around the majority of the perimeter of each sequin forming the reel.

### Experimental Characterisation of Shape, Microstructure and Optical Characteristics

Referring also to FIGS. 17A to 17D, SEM images are presented.

Each SEM image was obtained showing the cross-section of membranes 2000a of the first type at the perimeters 2009 thereof. The membranes 2000a were broken (bent to fracture) through the middle to allow imaging the cross-section of the membrane 2000a.

All of FIGS. 17A to 17D show the membrane 2000a curving back on itself to form recurved portions 2013. It may be observed that pseudo layers in the microstructure remain continuous as the membrane 2000a curves back on itself. The samples were sputter coated with 7 nm of carbon. Images taken with Zeiss Gemini ultra plus.

Referring in particular to FIG. 17A, the observed edge effects generally correspond to a combination of those illustrated in FIGS. 11, 13A and 13F.

Referring in particular to FIG. 17B, the observed edge effects generally correspond to a combination of those illustrated in FIG. 13G.

Referring in particular to FIG. 17C, the observed edge effects generally correspond to a combination of those illustrated in FIGS. 13C and 13D.

Referring in particular to FIG. 17D, the observed edge effects generally correspond to a combination of those illustrated in FIGS. 11, 13A and 13F.

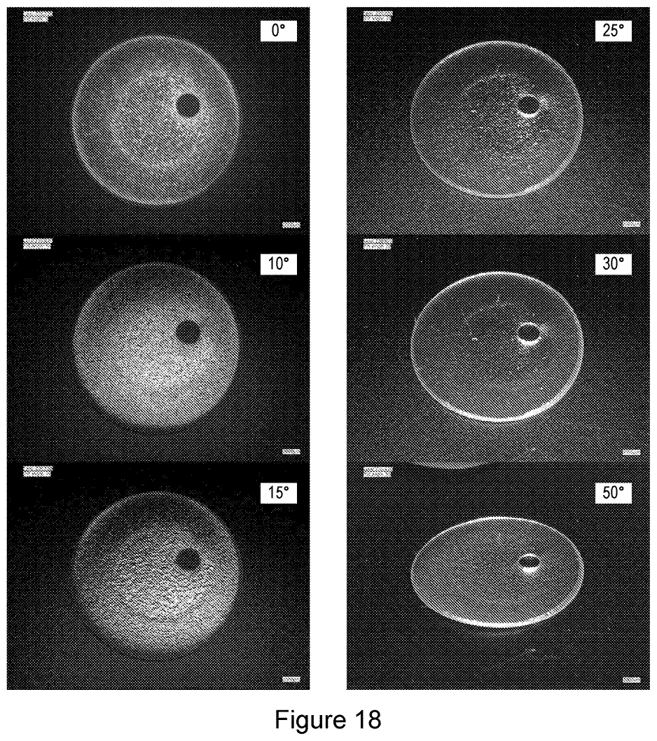

Referring also to FIG. 18, optical microscopy from a range of observation angles is shown for a cellulose nanocrystal membrane 2000a in the form of a sequin.

It may be observed that the colour and intensity of structural colour exhibit angular dependence, produced by the self-assembled cellulose nanocrystal microstructure. Images were taken with a Keyence (RTM) VHX-7000N instrument.

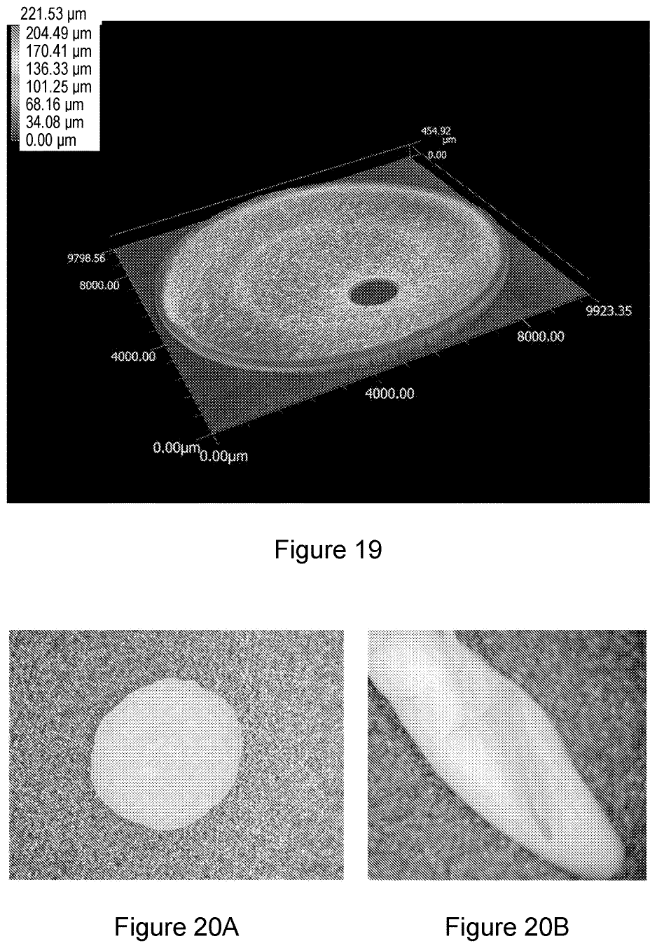

Referring also to FIG. 19, a 3D optical image of the cellulose nanocrystal sequin shown in FIG. 18 is presented.

The edge effect (recurved portions 2013) may be observed around the perimeter 2009. The height hr of recurved portions 2013 is about double the thickness at the centroid of the membrane. Data for FIG. 19 was obtained using a Keyence (RTM) VHX-7000N instrument.

Referring also to FIGS. 20A and 20B, photographs are shown of a membrane 2000b of the second type. FIG. 20A is oriented in an approximate plan view. FIG. 20B shows an edge-one view of a fracture cross-section of the membrane 2000b shown in FIG. 20A.

The pictured membrane 2000b was produced to have a curved edge around the perimeter 2009, with a minimum radius of curvature rₘᵢₙ which is around a quarter the thickness of the centroid 2008. The pictured membrane 2000b was produced on a hydrophobic substrate of silicone rubber (as a template 2015), so creating a curved smooth edge instead of the recurved portion 2013 of the first type of membrane 2000a.

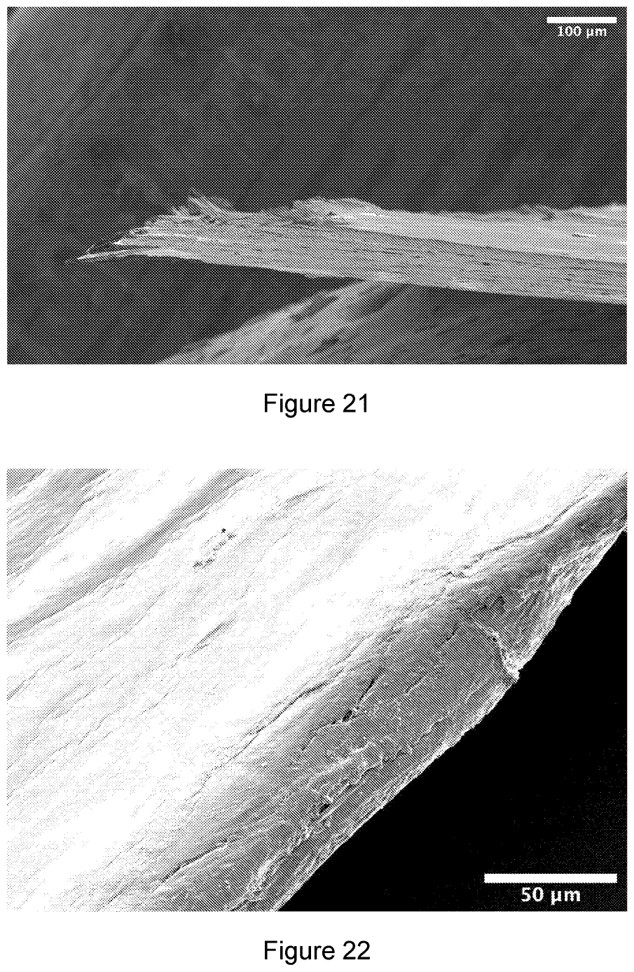

Referring also to FIG. 21 a scanning electron microscope (SEM) cross-section image is shown for a comparative example film.

The comparative example film was produced with the same cellulose nanocrystal suspension 2003 as the membranes 2000a shown in FIGS. 17A to 17D, example that instead of being dried in a mould 2001 as described herein, the suspension 20003 for the comparative example film was dispensed into and dried within a petri dish. The comparative example film was sputter coated with 10 nm of carbon prior to SEM imaging.

A break at the edge of the comparative example film may be observed in FIG. 21, corresponding to a point where the comparative example film met the edge of the petri dish. It may be observed that the pseudo layers remained well aligned, and the cholesteric axis did not change angle from the bulk of the comparative example film compared to the edge, resulting in a weak point at this edge (where it breaks).

Without wishing to be bound by theory, this is believed to be caused by anchoring to the petri dish dominating over domain and cholesteric axis alignment. When the anchoring to the petri dish dominates, this is believed to produce an edge effect where the helical axis changes sharply, causing a break and leaving a sharp edge. This sharp edge is brittle and exposed, causing the material to break further, tear, and/or catch onto other materials.

In contrast to the comparative example film shown in FIG. 21, referring also to FIG. 22 a scanning electron microscope image is shown for an example of the second type of membrane 2000b.

The example of the second type of membrane 2000b shown in FIG. 22 may be observed to exhibit a smooth, non-sharp edge, within a minimum radius of curvature retaining a significant fraction (greater than 0.1 time) the thickness at the centroid. The second type of membrane 2000b was sputter coated with 10 nm of carbon prior to SEM imaging.

Once fully dried, membranes 2000a, 2000b may be post-processed with a heat treatment. The heat treatment may be with or without application of pressure to the membrane 2000a, 2000b.

Once fully dried, membranes 2000a, 2000b may be post-processed with a alkaline treatment. The alkaline treatment may be with or without application of heat to the membrane 2000a, 2000b.

These membranes can be attached to different substrates in a variety of ways, including being sewn onto textiles creating a sequined fabric, this can be used for a variety of different industries and use cases.

It will be appreciated from the discussion above that the embodiments shown in the Figures are merely exemplary, and include features which may be generalised, removed or replaced as described herein and as set out in the claims. In the context of the present disclosure other examples and variations of the apparatus and methods described herein will be apparent to a person of skill in the art.

1-61. (canceled)

62. A membrane formed of a self-assembled microstructure of anisotropic nanocrystals and having a centroid and a perimeter, wherein around a majority of the perimeter the membrane curves back on itself.

63. A membrane formed of a self-assembled microstructure of anisotropic nanocrystals and having an upper surface, a lower surface, a centroid and a perimeter, wherein moving from the upper surface to the lower surface around any point on the perimeter, a minimum radius of curvature is at least 0.1 times the thickness of the membrane at the centroid.

64. The membrane of claim 63, wherein the anisotropic nanocrystals comprise a volume fraction of at least 70 wt % of the self-assembled microstructure.

65. The membrane of claim 63, wherein the membrane was formed as a single piece by drying of a suspension comprising the anisotropic nanocrystals.

66. The membrane of claim 63, wherein the self-assembled microstructure of anisotropic nanocrystals exhibits structural colour.

67. The membrane of claim 63, wherein the self-assembled microstructure of anisotropic nanocrystals comprises one or more pigments.

68. The membrane of claim 63, wherein the self-assembled microstructure of anisotropic nanocrystals comprises one or more additives.

69. The membrane of claim 68, wherein the one or more additives comprise at least one type of inorganic particle.

70. The membrane of claim 68, wherein the one or more additives comprise fibres.

71. The membrane of claim 68, wherein the one or more additives comprise at least one polymer.

72. The membrane of claim 63, wherein the membrane is mechanically self-supporting.

73. The membrane of claim 63, further comprising one or more through-holes.

74. The membrane of claim 63, wherein the self-assembled microstructure of anisotropic nanocrystals reflects light at a target wavelength.

75. The membrane of claim 63, wherein the anisotropic nanocrystals are formed of a biopolymer.

76. The membrane of claim 75, wherein the anisotropic nanocrystals are cellulose nanocrystals.

77. An article comprising the membrane of claim 63, supported on a substrate.

78. An article comprising the membrane of claim 63, bonded between a first layer and a second layer.

79. An article comprising the membrane of claim 63, further comprising a coating covering at least one surface of the membrane.

80. An article comprising the membrane of claim 63, embedded in a transparent material.

81. An iridescent sequin comprising cellulose nanocrystals, a plasticizer and a cross-linking agent.
